(19) United States
(12) Patent Application Publication
(10) Pub. No.: US 2012/0008476 A1
(43) Pub. Date: Jan. 12, 2012

(54) INFORMATION REPRODUCTION APPARATUS AND METHOD FOR CONTROLLING SAME

(75) Inventors: Kazuto Kuroda, Kanagawa-ken (JP); Kazuo Watabe, Kanagawa-ken (JP); Hideaki Okano, Kanagawa-ken (JP); Akihito Ogawa, Kanagawa-ken (JP); Takashi Usui, Saitama-ken (JP)

(73) Assignee: KABUSHIKI KAISHA TOSHIBA, Tokyo (JP)

(21) Appl. No.: 13/238,612

(22) Filed: Sep. 21, 2011

Related U.S. Application Data
(63) Continuation of application No. PCT/JP2009/064147, filed on Aug. 10, 2009.

(51) Int. Cl. G11B 7/135

(52) U.S. Cl. 369/47.49; G9B/7.124

(57) ABSTRACT

According to one embodiment, an information reproduction apparatus includes an information acquisition unit, an error detection unit, and a control unit. The information acquisition unit is configured to irradiate a reference beam, convert the reference beam into a luminance signal, and output the luminance signal when reproducing an information recording Medium. The error detection unit is configured to detect at least one selected from a first error and a second error by extracting a feature extraction quantity from the luminance signal. The first error is of an irradiation angle of the reference beam. The second error is of at least one selected from a temperature and a wavelength of the reference beam. The control unit is configured to control at least one selected from the irradiation angle and the at least one selected from the reproduction temperature and the wavelength of the reference beam using the second error.

### CROSS-REFERENCE TO RELATED APPLICATIONS

This is a continuation application of International Application PCT/JP2009/064147, filed on Aug. 10, 2009. The entire contents of which are incorporated herein by reference.

### FIELD

Embodiments described herein relate generally to an information reproduction apparatus and method for controlling same.

### BACKGROUND

Information recording and reproducing methods include holographic storage in which holography is used to three-dimensionally record information as an interference pattern in a recording medium. Although increased capacities are possible using multiplex recording, it is necessary to accurately control the position and the angle of the reference beam to reproduce the information from the recording medium. Moreover, because the characteristics of the recording medium depend on the wavelength of the reference beam and the temperature, it is necessary also to control the temperature of the recording medium and the wavelength of the reference beam when reproducing.

Therefore, methods have been proposed to control the wavelength of the reference beam and the irradiation angle onto the recording medium to maximize the sum total luminance of the reproduced information beam (for example, see “Kevin Curtis (InPhase Technologies Inc.), Holographic Storage; Advanced Systems and Media, pp. 104-113, ISOM/ODS2008 SC917”). Also, to narrow the range of search, methods have been proposed to correct the wavelength of the laser beam beforehand from the medium temperature by using a radiation thermometer (for example, see “Kevin Curtis et. al., Practical issues of servo, lenses, lasers, drives and media for HDS, pp. 1-7, IWHM 2008 Digest”).

### BRIEF DESCRIPTION OF THE DRAWINGS

FIG. 1 is a schematic perspective view of an information reproduction apparatus according to an embodiment;

FIG. 2 is a flowchart of a method for controlling an information reproduction apparatus according to the embodiment;

FIG. 3 is a schematic side view of the information reproduction apparatus illustrated in FIG. 1;

FIG. 4 is a schematic cross-sectional view of the information recording medium;

FIGS. 5A to 5C are schematic perspective views illustrating the relationship between the information recording medium and the reference beam;

FIG. 6 is a basic flowchart of the method for controlling the information reproduction apparatus;

FIG. 7 is a detailed flowchart of the pull-in operation;

FIG. 8 is a detailed flowchart of the servo operation;

FIG. 9 is a schematic view illustrating the reproduced luminance signal;

FIG. 10 is another schematic view illustrating the reproduced luminance signal;

FIG. 11 is a flowchart of the angle control;

FIGS. 12A and 12B are other schematic views illustrating the reproduced luminance signal;

FIG. 13 is another schematic view illustrating the reproduced luminance signal;

FIG. 14 is a flowchart of the wavelength control;

FIG. 15 is another schematic view illustrating the reproduced luminance signal;

FIG. 16 is a graph illustrating the output of the error detection unit;

FIG. 17 is another graph illustrating the output of the error detection unit;

FIGS. 18A to 18C are graphs illustrating the detection process of the angle error in normal reproduction;

FIG. 19 is a flowchart of the angle control in normal reproduction;

FIG. 20 is a flowchart that extracts the feature extraction quantity from the luminance signal;

FIG. 21 is a schematic perspective view of the information reproduction apparatus according to another embodiment;

FIG. 22 is a schematic perspective view when recording the information recording medium;

FIG. 23 is a table that illustrates the luminance distribution tilt; and

FIG. 24 is a table that illustrates the center position.

### DETAILED DESCRIPTION

In general, according to one embodiment, an information reproduction apparatus includes an information acquisition unit, an error detection unit, and a control unit. The information acquisition unit is configured to irradiate a reference beam, convert the reference beam into a luminance signal using a first light detector, and output the luminance signal when reproducing an information recording medium. An interference pattern of the reference beam and an information beam is formed in the information recording medium. The error detection unit is configured to detect at least one selected from a first error and a second error by extracting a feature extraction quantity from the luminance signal. The first error is of an irradiation angle of the reference beam. The second error is of at least one selected from a temperature when reproducing the information recording medium and a wavelength of the reference beam. The control unit is configured to control at least one selected from the irradiation angle of the reference beam relative to the information recording medium using the first error and the at least one selected from the reproduction temperature and the wavelength of the reference beam using the second error.

Embodiments will now be described in detail with reference to the drawings.

The drawings are schematic or conceptual; and the relationships between the configuration and width of portions, the proportions of sizes among portions, etc., are not necessarily the same as the actual values thereof. Further, the dimensions and the proportions may be illustrated differently among the drawings, even for identical portions.

In the specification and the drawings of the application, components similar to those described in regard to a drawing thereinabove are marked with like reference numerals, and a detailed description is omitted as appropriate.

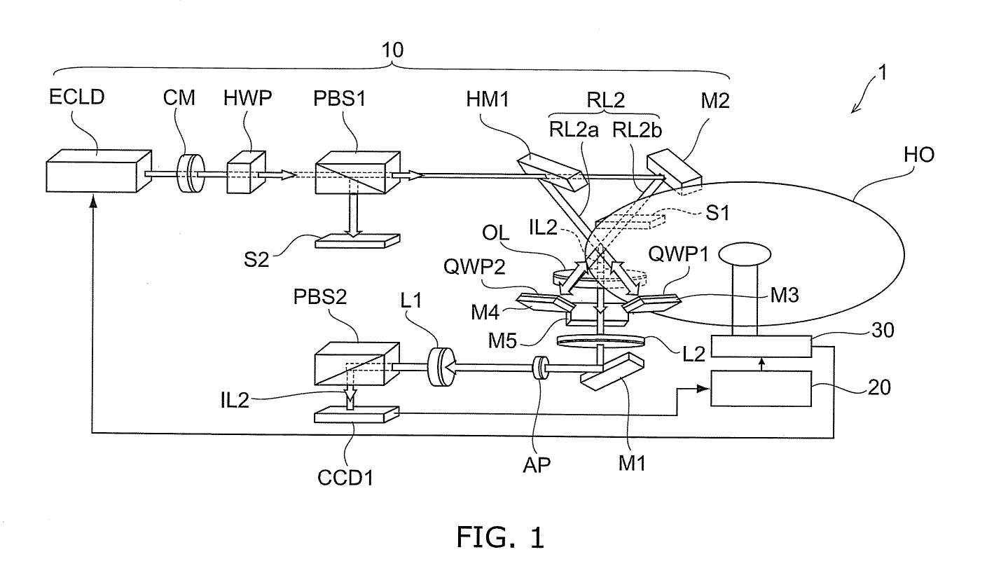

FIG. 1 is a schematic perspective view of an information reproduction apparatus according to an embodiment.

As illustrated in FIG. 1, the information reproduction apparatus 1 includes an information acquisition unit 10, an error detection unit 20, and a control unit 30.

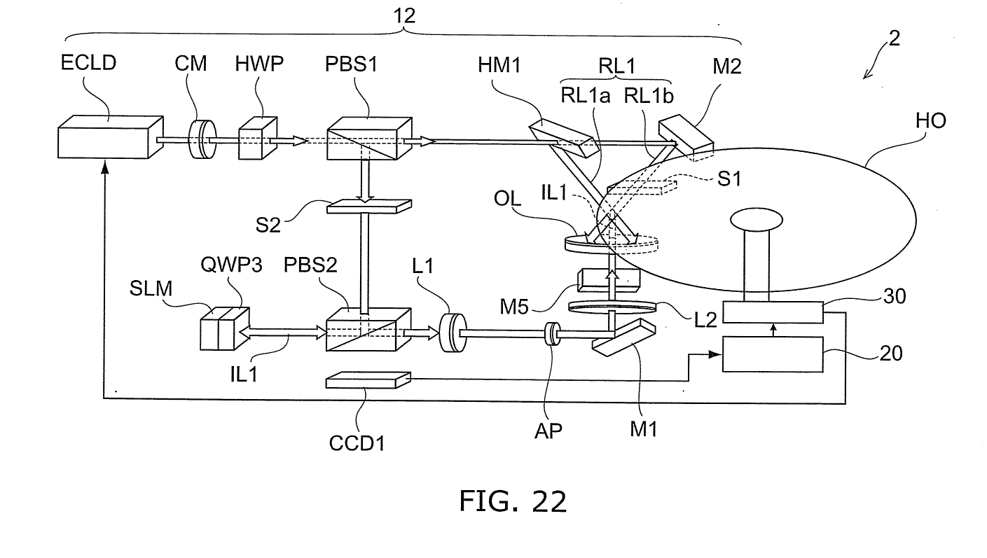

The information acquisition unit 10 is configured to irradiate a reference beam RL2 onto an information recording medium HO, acquire an information beam IL2, convert the information beam IL2 into a two-dimensional luminance signal, and output the luminance signal. Herein, the information recording medium HO is a hologram in which an interference pattern of a reference beam RL1 (FIG. 22) and an information beam IL1 is formed.

The error detection unit 20 is configured to extract a feature extraction quantity from the two-dimensional luminance signal acquired by the information acquisition unit 10. Then, a first error and a second error are detected from the feature extraction quantity. Herein, the first error is the error between the ideal irradiation angle and the actual irradiation angle of the reference beam RL2 with respect to the information recording medium HO. Herein, the ideal irradiation angle is the angle at which the information of the reproduced information beam IL2 matches the information of an information beam IL1 of the recording (FIG. 22). Although this angle basically matches the irradiation angle of the reference beam RL1 of the recording (FIG. 22), this angle changes due to the temperature difference between the recording and the reproducing, expansion, contraction, etc., of the medium, etc.

The second error is the error between the actual wavelength of the reference beam RL2 and the ideal wavelength. Herein, the ideal wavelength is the wavelength at which the information of the reproduced information beam IL2 matches the information of the information beam IL1 of the recording. Although this wavelength basically matches the wavelength of the reference beam RL1 of the recording, this wavelength changes due to the temperature difference between the recording and the reproducing, the expansion, contraction, etc., of the medium, etc. The second error may be the error between the actual temperature when reproducing the information recording medium HO and the ideal temperature. Herein, although the ideal temperature basically is the temperature of the information recording medium HO of the recording, this temperature changes due to the shift of the wavelength of the reference beam between the recording and the reproducing, the expansion, contraction, etc., of the medium, etc.

The control unit 30 controls irradiation angles θx and θy of the reference beam RL2 with respect to the information recording medium HO and a wavelength λ using the first and second errors detected by the error detection unit 20 such that the optimal information beam IL2 can be acquired. Although the control unit 30 is illustrated as being linked to the medium in FIG. 1, the irradiation angles θx and θy are realizable not only by controlling the angle of the information recording medium HO but also by controlling mirrors M2 to M4, the angle of a half mirror HM1, etc.

The information reproduction apparatus 1 is configured to reproduce the information recorded in the information recording medium HO.

The information acquisition unit 10, the error detection unit 20, and the control unit 30 will now be described.

The information acquisition unit 10 includes a light source ECLD, a collimating lens CM, a λ/2 plate HWP, polarizing beam splitters PBS1 and PBS2, a half mirror HM1, mirrors M1 to M5, shutters S1 and S2, an objective lens OL, λ/4 plates QWP1 and QWP2, lenses L1 and L2, an aperture AP, and a first light detector CCD1.

The light source ECLD is a semiconductor laser having an external resonator and variable wavelengths with, for example, a wavelength of 405 nm in the bluish-violet wavelength band. The laser beam radiated from the light source ECLD is irradiated onto the collimating lens CM. The laser beam emerging from the collimating lens CM is parallel light that passes through the λ/2 plate HWP to be irradiated onto the polarizing beam splitter PBS1.

The laser beam irradiated onto the polarizing beam splitter PBS1 branches into two systems (the P-polarized light is transmitted and the S-polarized light is reflected). As illustrated in FIG. 1, the laser beam branching in the downward direction is not used in the reproducing and therefore is optically shielded by the shutter S2. The laser beam passing through the polarizing beam splitter PBS1 as the reference beam RL2 in the lateral direction in FIG. 1 is split into reference beams RL2a and RL2b by the half mirror HM1 and the mirror M2. The reference beams RL2a and RL2b are used as the reference beam RL2 when reproducing the multiplex-recorded information from the information recording medium HO.

The reference beam RL2a passes through the information recording medium HO from below. The reference beam RL2a passes through the λ/4 plate QWP1, is reflected by the reproduction mirror M3, and again passes through the λ/4 plate QWP1 in the reverse direction. Then, the reference beam RL2a is irradiated onto the location on the information recording medium HO where the information to be read is recorded.

Similarly, the reference beam RL2b also passes through the information recording medium HO. The reference beam RL2b passes through the λ/4 plate QWP2, is reflected by the reproduction mirror M4, and again passes through the λ/4 plate QWP2 in the reverse direction. Then, the reference beam RL2b is irradiated onto substantially the same location on the information recording medium HO where the information to be read is recorded.

The information reproduction apparatus 1 is a holographic storage apparatus using phase conjugate reproduction.

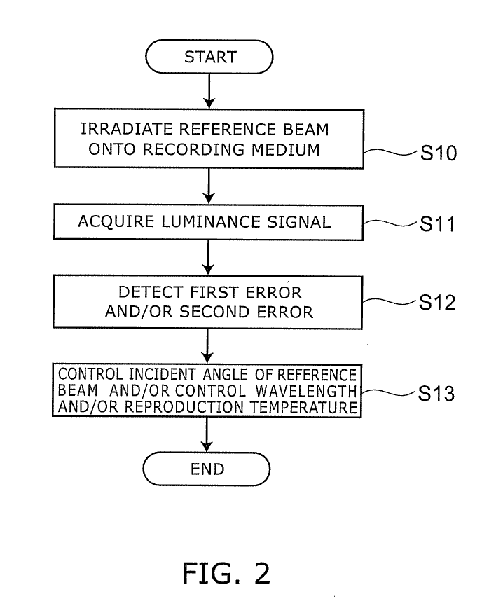

FIG. 2 is a flowchart of a method for controlling an information reproduction apparatus according to the embodiment.

FIG. 2 illustrates the method for controlling the information reproduction apparatus 1 illustrated in FIG. 1.

In a first step as illustrated in FIG. 2, first, the reference beam RL2 is irradiated (S10).

In a second step, the information beam IL2 produced by the reference beam RL2 is received by the first light detector CCD1 and sent to the error detection unit 20 as a luminance signal (S11).

In a third step, the error detection unit 20 detects a first error between the ideal irradiation angle and the actual irradiation angle of the reference beam RL2 with respect to the information recording medium HO from the luminance signal; and/or the error detection unit 20 detects a second error between the ideal wavelength and the actual wavelength of the reference beam RL2 (S12).

In other words, one selected from the first error and the second error may be detected; or both may be detected. The detailed method for detecting the first error and the second error is described below. The second error may be the error between the ideal temperature and the actual temperature when reproducing the information recording medium HO.

In a fourth step, the control unit 30 controls the relative angle between the information recording medium HO and the reference beam RL2 such that the detected first error becomes 0 (S13). And/or, the wavelength of the reference beam RL2 is changed by controlling the light source ECLD such that the second error becomes 0 (S13).

Here, the temperature of the information recording medium HO may be controlled such that the second error becomes 0 by a temperature control apparatus not illustrated in FIG. 1.

In other words, in the fourth step in the case of the control such that the second error becomes 0, both the wavelength of the reference beam RL2 and the temperature of the information recording medium HO may be controlled; or only one selected from the wavelength of the reference beam RL2 and the temperature of the information recording medium HO may be controlled.

In the case of the control such that the first error and the second error become 0, both the first error and the second error may be controlled simultaneously to become 0; or only one selected from the first error and the second error may be controlled to become 0.

By completing the fourth step, the wavelength of the reference beam RL2 and the relative angle between the information recording medium HO and the reference beam RL2 reach the ideal states; and the information reproduction apparatus 1 can accurately read the information recorded in the information recording medium HO.

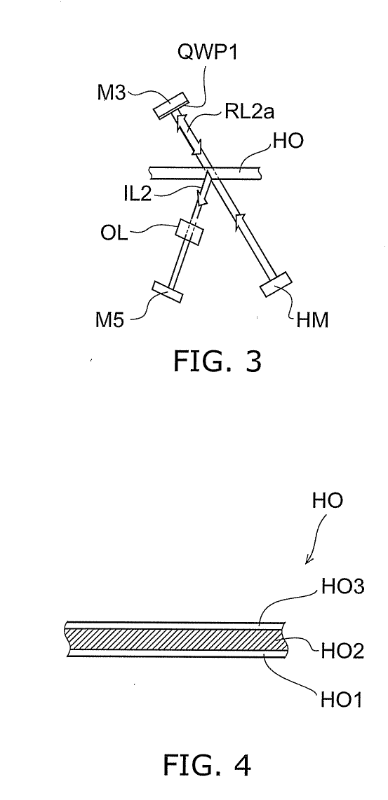

FIG. 3 is a schematic side view of the information reproduction apparatus illustrated in FIG. 1.

FIG. 3 schematically illustrates a configuration in which the reference beam RL2a is irradiated onto the information recording medium HO and the information beam IL2 reproduced from the information recording medium HO is irradiated onto the objective lens OL.

As illustrated in FIG. 3, the reference beam RL2 (RL2a and RL2b) passing through the information recording medium HO is reflected by the reproduction mirror M3 or the reproduction mirror M4. The information beam IL2 is reproduced from the interference pattern recorded in the information recording medium HO by the reference beam RL2a or RL2b irradiated from the side of the information recording medium HO opposite to the objective lens OL; and the information beam IL2 is irradiated onto the objective lens OL.

Returning again to FIG. 1, the information beam IL2 passing through the objective lens OL is reflected by the reflect mirror M5. Then, the information beam IL2 passes through and is reflected by the lens L2, the mirror M1, the aperture AP, and the lens L1 in this order. Then, the information beam IL2, which has become parallel light by passing through the lens L1, is reflected by the polarizing beam splitter PBS2 and is irradiated onto the first light detector CCD1.

In the first light detector CCD1, the information stored in the information recording medium HO is reproduced as a luminance signal. When reproducing the information, one selected from the reference beam RL2a and the reference beam RL2b is optically shielded constantly by the shutter S1. On the information recording medium HO, the reference beam RL2a or the reference beam RL2b is irradiated onto the location on the information recording medium HO where the information to be read is recorded.

The page data recorded by the information beam IL1 for recording and a reference beam RL1a for recording, which travels the same path as the reference beam RL2a, is reproduced by irradiating the reference beam RL2a for reproducing. Similarly, the page data recorded by the information beam IL1 for recording and a reference beam RL1b for recording, which travels the same path as the reference beam RL2b, is reproduced by irradiating the reference beam RL2b for reproducing.

In the recording of the information recording medium HO as illustrated in FIG. 22, the page data is two-dimensionally arranged binary data. In other words, when recording, the luminance of the information beam is modulated to correspond to binary data. When reproducing, the acquired information beam IL2 is converted into a luminance signal of, for example, one byte per pixel and output as one page of page data by the first light detector CCD1.

The information reproduction apparatus 1 illustrates the case where the information recording medium HO having multiplex recording using the reference beams RL1a and RL1b of different irradiation angles is reproduced respectively using the reference beams RL2a and RL2b. However, this is not limited thereto. The information recording medium having multiplex recording can be reproduced by irradiating the reference beam RL2 at any number of one or more irradiation angles. The multiplicity of the multiplex recording is limited by the characteristics of the recording medium of the information recording medium HO.

FIG. 4 is a schematic cross-sectional view of the information recording medium.

As illustrated in FIG. 4, the information recording medium HO is a holographic storage medium having a configuration in which a recording medium HO2 configured to record information is interposed between a transparent substrate HO1 and a transparent substrate HO3.

The transparent substrates HO1 and HO3 are used to maintain the configuration of the recording layer while reducing the effects of scratches and dust occurring on the surfaces of the recording layer. The raw material may include glass, polycarbonate, acrylic resin, etc. Other materials may be used if the optical characteristics with respect to the laser wavelength used, the mechanical strength characteristics, the dimensional stability, the moldability, etc., are sufficient.

The recording medium HO2 is responsive to the laser beam for recording. Typical materials include photopolymers. A photopolymer is a photosensitive material utilizing the photopolymerization of a polymerizable compound (a monomer) and generally contains as the main components a matrix of a monomer, a photopolymerization initiator, and a porous configuration that performs the role of maintaining the volume before and after the recording. Other than photopolymers, a layer made of a hologram-recordable medium such as a dichromated gelatin, a photorefractive crystal, etc., may be used.

Although the thickness of each of the portions is not particularly limited, for example, the thickness of each of the transparent substrates HO1 and HO3 may be 0.5 mm; and the thickness of the recording medium HO2 may be 1.0 mm.

The planar configuration of the information recording medium HO may be, for example, circular as illustrated in FIG. 1 (e.g., with a diameter of 12 cm). Configurations such as squares, rectangles, ellipses, other polygons, etc., also may be used.

Returning again to FIG. 1, the reproduced information beam IL2 is converted into an electrical signal by the first light detector CCD1; and the luminance signal is transmitted to the error detection unit 20 as image information. The error detection unit 20 detects the first error and the second error by extracting a feature extraction quantity based on the luminance signal, i.e., the luminance distribution of the reproduced information beam IL2 (the image information).

The feature extraction quantity is described below.

As recited above, the first error is the error of the relative irradiation angle between the reference beam RL2 and the information recording medium HO. The second error is the wavelength error of the reference beam RL2 or the temperature error when reproducing.

For the information beam IL2, the error of the wavelength and the error of the temperature recited above are related to each other. For example, a good reproducing state can be obtained by correcting the temperature error by changing the wavelength of the reference beam RL2 even in the case where there is an error of the temperature.

Therefore, in the case where there is no temperature error, the second error is equal to the wavelength error; and in the case where there is a temperature error, the second error is a synthesis of the temperature error and the wavelength error.

Here, as recited above, a good reproducing state can be obtained by correcting the temperature error by changing the wavelength of the reference beam RL2 even in the state in which there is a temperature error. Therefore, the second error in the case where there is a temperature error can be considered to be the wavelength error between the actual wavelength and the optimal wavelength of the reference beam RL2 to correct the temperature error.

It is also possible to obtain a good reproducing state by causing the temperature of the information recording medium HO to change even in the state where there is an error of the wavelength. In such a case, the second error can be considered to be the temperature error between the current temperature of the information recording medium and the optimal temperature of the information recording medium to correct the wavelength error.

The first and second errors are sent to the control unit 30 from the error detection unit 20.

The control unit 30 is physically connected to the information recording medium HO such that the control of the three-dimensional position and the rotation of the information recording medium HO is possible. A wavelength control signal configured to control the wavelength of the light source ECLD is output to the light source ECLD from the control unit 30.

The control unit 30 causes the three-dimensional position/tilt of the information recording medium HO to displace based on the first and second errors detected by the error detection unit 20. The irradiation angle of the reference beam RL2 is controlled while the information recording medium HO is guided to the desired position. The wavelength of the light source ECLD, which is the wavelength of the reference beam RL2, is controlled.

The information reproduction apparatus 1 is illustrated with a configuration in which the irradiation angle of the reference beam RL2 is controlled by the control unit 30 causing the three-dimensional position/tilt of the information recording medium HO to displace. However, this is not limited thereto. The tilt of the information recording medium HO may be maintained at a constant; and the angle of the reference beam RL2 for reproducing may be controlled by causing the angles of the half mirror HM1 and the mirrors M2, M3, and M4 to change.

As illustrated in FIG. 22, one selected from the reference beams RL1a and RL1b is optically shielded constantly by the shutter S1 when recording information. The reference beam RL1a and the information beam IL1 are irradiated simultaneously onto the information recording medium HO; or the reference beam RL1b and the information beam IL1 are irradiated simultaneously onto the information recording medium HO.

Accordingly, refractive index variation based on the interference pattern of the information beam IL1 (IL1a and IL1b) and the reference beam RL1 (RL1a and RL1b) is multiplex-recorded as page data in the information recording medium HO. This is the θz angular multiplex recording around the z axis described below. Also, θy angular multiplexing is performed by causing the relative angles θy around the y axis between the reference beams RL1a and RL1b and the information recording medium HO described below to change when recording the information. In the following description, the direction around θy which has a particularly large multiplex number is taken as the multiplex direction.

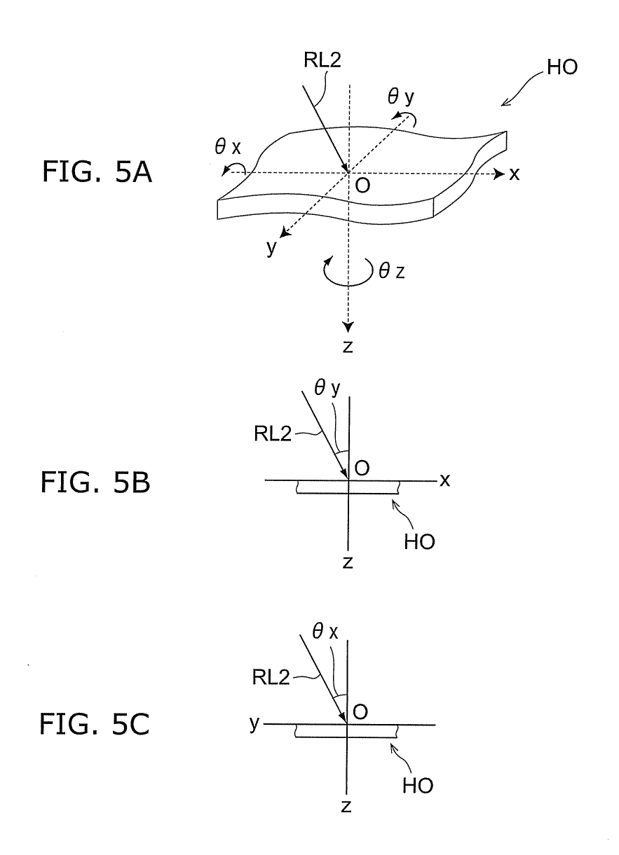

FIGS. 5A to 5C are schematic views illustrating angles between the information recording medium and the reference beam.

FIG. 5A is a schematic perspective view illustrating the relationship between the information recording medium HO and the reference beam RL2. FIG. 5B and FIG. 5C illustrate the relationship between the information recording medium HO and the reference beam RL2 as viewed from a direction (the positive direction of the y axis) perpendicular to the multiplex direction (around the y axis) and as viewed from a direction (the positive direction of the x axis) parallel to the multiplex direction (around the y axis), respectively.

As illustrated in FIG. 5A, the extension direction of the information recording medium HO is taken to be in the xy plane; and the z axis is taken to be in the thickness direction of the medium perpendicular to the xy plane. Rotations around the z axis are taken as θz. As recited above, the information recording medium HO is a holographic storage medium having angular multiplex recording in the rotation (θy) direction around the y axis.

As illustrated in FIG. 5B and FIG. 5C, the irradiation angles θx and θy of the reference beam RL2 are rotation angles from the z axis around the x axis and around the y axis, respectively. Although not illustrated, the irradiation angles of the reference beam RL1 for recording are taken as θx1 and θy1.

As illustrated in FIGS. 5A to 5C, the irradiation angles θx and θy are relative angles with respect to the information recording medium HO.

In the plane of the information recording medium HO, the direction around the axis of the direction substantially orthogonal to the emergence direction of the information beam has high angular selectivity. In other words, it is possible to record more information in the same range of angles. Therefore, the axis of this direction of high angular selectivity in the plane of the information recording medium HO is taken as the first axis. In the case of angular multiplex recording, the multiplex recording is performed by changing the angle around the first axis. An axis orthogonal to the first axis in the plane of the information recording medium is taken as the second axis.

In this example, the first axis is the y axis having angular multiplex recording; and the second axis is the x axis.

As illustrated in FIG. 1, in the case where, for example, the planar configuration of the information recording medium HO is circular, the second axis (the x axis) is taken to be in the radial direction; the first axis (the y axis) is taken to be in the tangential direction; and the multiplex recording can be performed around the first axis (the y axis).

Operations of the information reproduction apparatus 1 will now be described.

As recited above, the error detection unit 20 is configured to detect the first and second errors of the reference beam RL2 irradiated onto the information recording medium HO by extracting the feature extraction quantity from the luminance signal of the first light detector CCD1. The control unit 30 is configured to control the irradiation angles θx and θy and the wavelength λ of the reference beam RL2 using the first and second errors. In this example as recited above, the axis of the multiplex recording in the information recording medium HO, i.e., the irradiation angle around the first axis, is taken as θy.

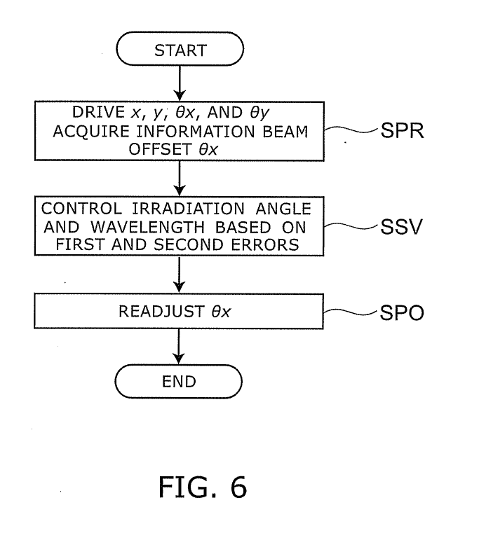

FIG. 6 is a basic flowchart of the method for controlling the information reproduction apparatus.

FIG. 6 illustrates the third step (S12) and the fourth step (S13) illustrated in FIG. 2 in detail.

As illustrated in FIG. 6, the control unit 30 controls to obtain the optimal reproducing state by performing the processing of a pull-in operation (step SPR), a servo operation (step SSV), and a readjustment of the irradiation angle θx (step SPO).

In the pull-in operation (step SPR), the control unit 30 controls the positions x and y and the irradiation angles θx and θy of the reference beam RL2 for reproducing, pulls the information beam IL2 diffracted from the information recording medium HO into the light receiving unit of the first light detector CCD1, and acquires the luminance signal. An offset is provided to the irradiation angle θx.

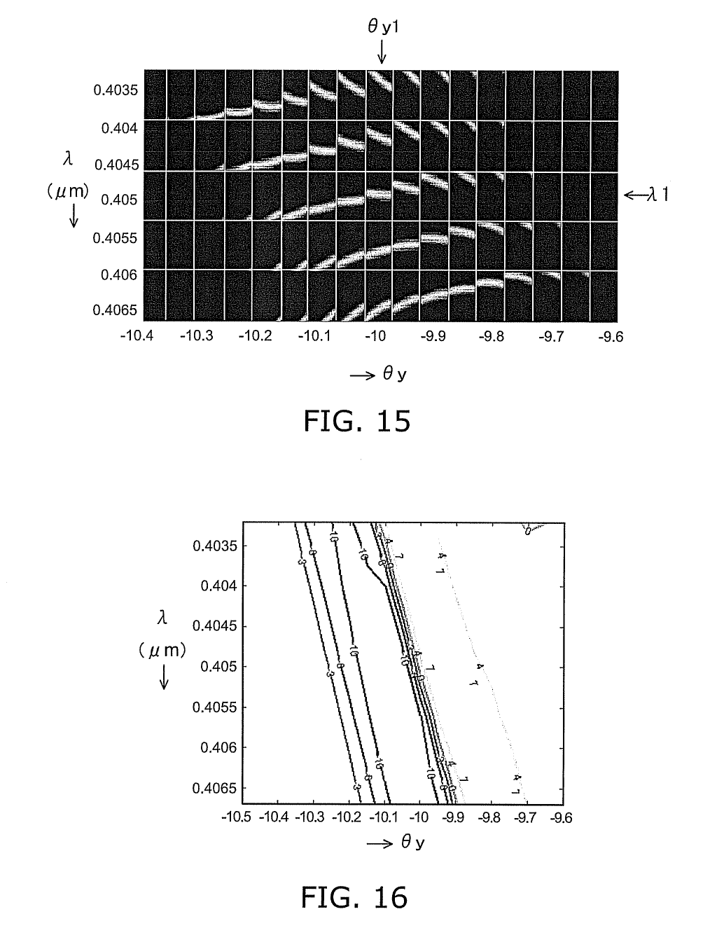

By providing a constant offset to the irradiation angle θx, the luminance signal of the information beam IL2 approaches a distribution of fine rod configurations as illustrated in FIG. 15. As a result, the binary processing when detecting the first and second errors in the subsequent servo operation (step SSV) can be implemented more accurately.

By providing an offset of a known polarity beforehand, the polarity of the irradiation angle θx is determined. As described below, this means that the polarities of the second error and the first error of the irradiation angle θy around the first axis are determined.

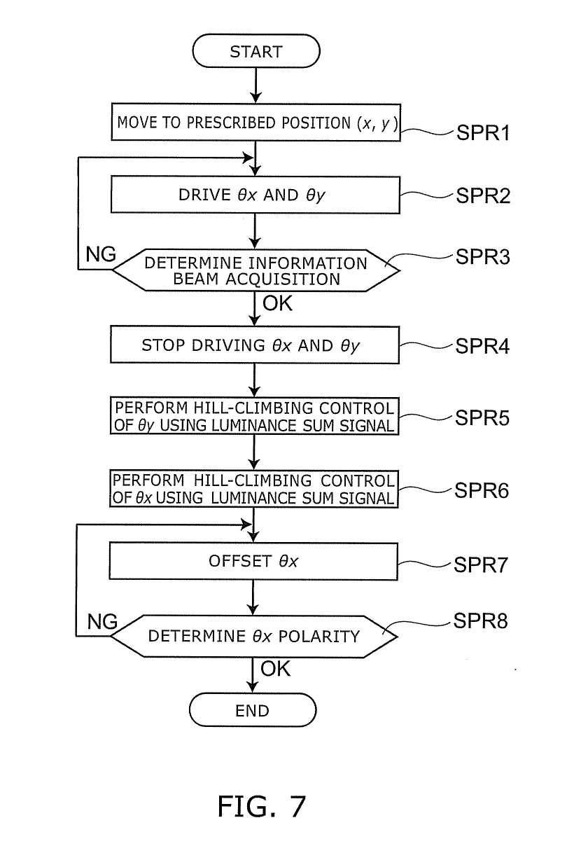

Details of the pull-in operation are illustrated in FIG. 7.

Returning again to FIG. 6, the irradiation angle θy and the wavelength λ are controlled simultaneously or alternately based on the first and second errors in the subsequent servo operation (step SSV). At this time, as illustrated in FIG. 15 to FIG. 17, convergence is possible stably and quickly by the servo gain of the irradiation angle θy being set to be higher than the servo gain of the wavelength λ.

As described below, the control of the irradiation angle θy and the wavelength λ is implemented such that the convergence speed of the control of the irradiation angle θy is faster than that of the control of the wavelength λ. To increase the convergence speed, the servo gain of the irradiation angle θy is higher than the servo gain of the wavelength λ as recited above. Also, this can be realized by starting the control of the irradiation angle θy slightly prior to the control of the wavelength λ.

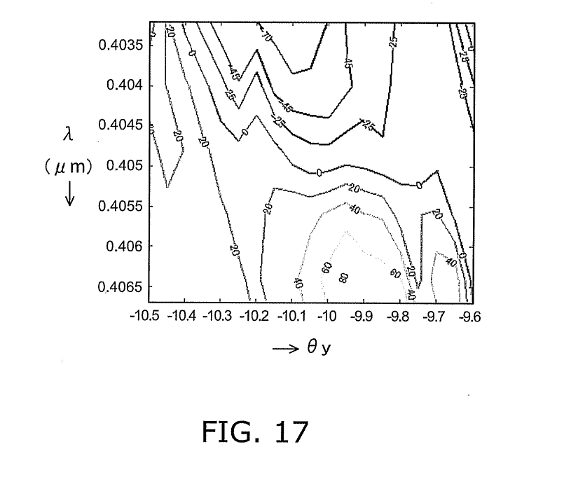

When the controls of both the irradiation angle θy and the wavelength λ have converged, the flow proceeds to the next step SPO. The simultaneous control of the irradiation angle θy and the wavelength λ will be described with reference to FIG. 16 and FIG. 17. Namely, although the first error of the irradiation angle θy and the second error of the wavelength λ interfere with each other, the effects of the interference can be suppressed and precise control can be realized by controlling the irradiation angle θy and the wavelength λ simultaneously or alternately.

Then, in the readjusting of the irradiation angle θx (step SPO), the irradiation angle θx is readjusted to restore the offset of the irradiation angle θx provided in the pull-in operation (step SPR). When the readjusting of the irradiation angle θx is completed and the complete page image is obtained, the control is completed.

The information reproduction apparatus 1 transitions to the normal reproducing state. Herein, the normal reproducing state is the state which is substantially satisfactory to obtain the recorded page data. The control unit 30 controls to maintain this state.

The pull-in operation (step SPR) and the servo operation (SSV) will now be described further.

FIG. 7 is a detailed flowchart of the pull-in operation.

As illustrated in FIG. 7, first, the positions x and y are moved to irradiate the reference beam RL2 onto a prescribed page position of the recording (step SPR1).

Scanning is performed such that the irradiation angles θx and θy of the reference beam RL2 are in a preset range (step SPR2). At this time, the first light detector CCD1 receives the information beam IL2 reproduced from the information recording medium; and the sum of the luminance signal, which is the output thereof, is calculated by, for example, an arithmetic circuit.

It is determined whether or not the information beam IL2 from recorded page data has been acquired by determining whether or not the calculated luminance sum signal exceeds a prescribed threshold value (step SPR3).

In the case where the result of the calculation exceeds the prescribed threshold value, it is determined that the first light detector CCD1 has captured a portion of the page image. In other words, it is determined that the information beam IL2 has been acquired (step SPR3: OK); and the flow proceeds to step SPR4.

In the case where the result of the calculation does not exceed the prescribed threshold value, it is determined that the information beam IL2 has not been acquired (step SPR3: NG); the flow returns to step SPR2; and the scanning of the irradiation angles θy and θx is continued.

The scanning of the irradiation angles θy and θx is stopped (step SPR4).

To capture the information beam IL2 more stably, a hill-climbing control of the irradiation angle θy is implemented such that the luminance sum signal reaches a maximum by controlling the irradiation angle θy again (step SPR5). Then, the irradiation angle θy is fixed at the value of the irradiation angle θy at which the luminance sum signal is the maximum; and the flow proceeds to step SPR6.

Normally, by the previous step SPR5, a portion having a high luminance is moved to be proximal to a central portion of the first light detector CCD1.

Similarly to the previous step SPR5, a hill-climbing control of the irradiation angle θx is implemented such that the luminance sum signal reaches a maximum by controlling the irradiation angle θx (step SPR6). Then, the irradiation angle θx is maintained at the value of the irradiation angle θx at which the luminance sum signal is the maximum; and the flow proceeds to step SPR7.

An offset of a constant quantity is added to the irradiation angle θx (step SPR7).

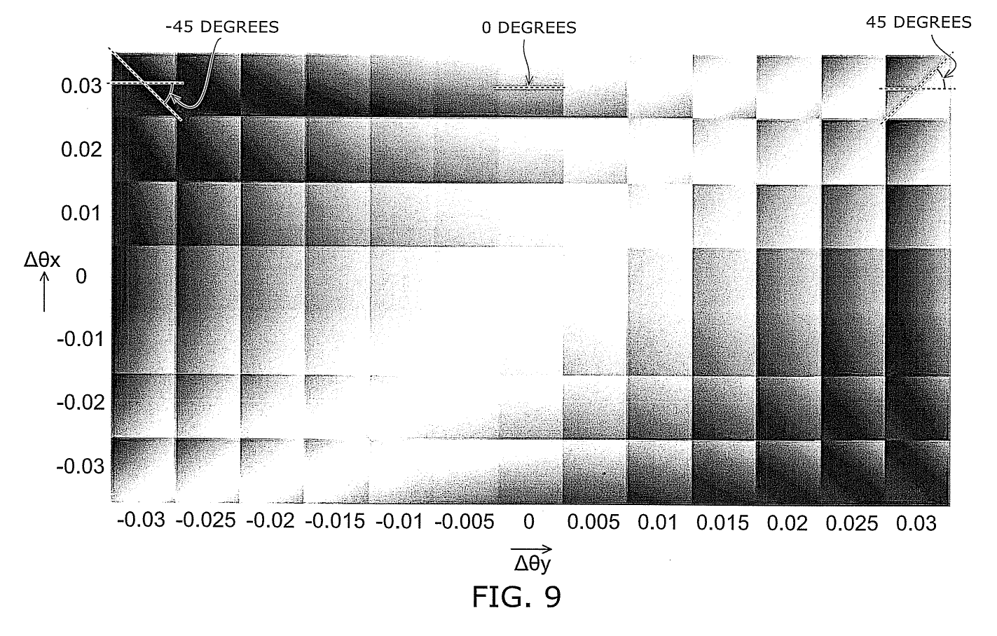

The polarity of the irradiation angle θx is determined (SPR8). As illustrated in FIG. 9, this is because the polarities of the first and second errors detected by the error detection unit 20 invert due to the polarity of the offset of the irradiation angle θx.

As described below, it is possible to detect the polarity of the irradiation angle θx using the direction of the change of the tilt of the luminance distribution when changing the irradiation angle θy by a constant step. Here, the pull-in operation is completed in the case where the detected polarity is the desired polarity. On the other hand, in the case where the detected polarity is different from the desired polarity, the flow returns to step SPR7; and the appropriate offset is provided to the irradiation angle θx.

By step SPR8: OK recited above, the state is reached in which the first and second errors are output from the error detection unit 20; the pull-in operation is completed; and the flow proceeds to the subsequent servo operation.

The object of the pull-in operation (step SPR) is not to obtain the complete page data; and it is sufficient for one portion of the page image to be captured inside the light receiving unit of the first light detector CCD1. Accordingly, the processing is completed in a short period of time by scanning the irradiation angles θx and θy, etc., which are relative angles between the information recording medium HO and the reference beam RL2, in a predefined range at a high speed, etc.

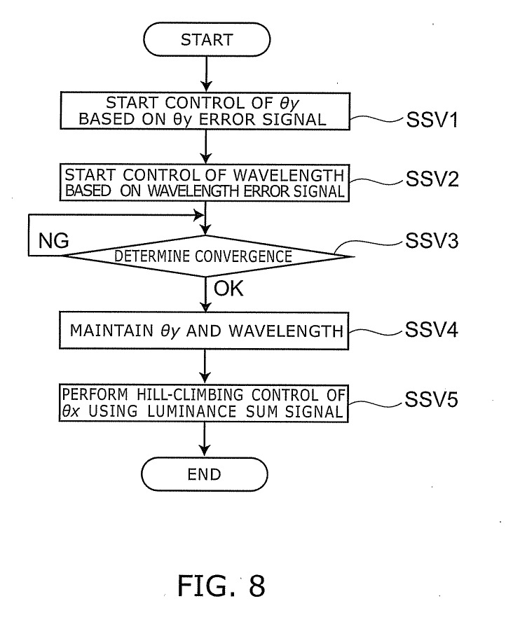

FIG. 8 is a detailed flowchart of the servo operation.

In the servo operation as illustrated in FIG. 8, a feedback control of the wavelength λ and the irradiation angle θy of the multiplex direction is performed such that the first error and the second error become 0.

A feedback control using the first error of the irradiation angle θy is started (step SSV1). Here, the control of the irradiation angle θy is implemented in a bandwidth higher than that of the control of the wavelength λ which is started in the subsequent step SSV2.

Then, the feedback control using the second error of the wavelength λ using circular ring center coordinates is started (step SSV2). The wavelength control implemented here is implemented in a bandwidth lower than that of the control of the irradiation angle θy started in the previous step SSV1.

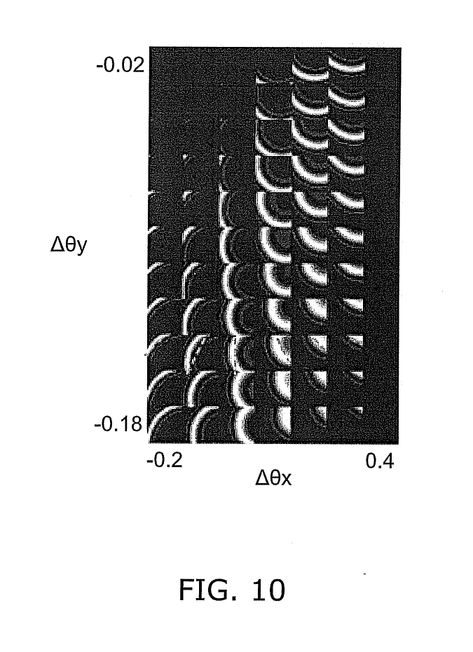

The method for detecting the first and second errors by the error detection unit 20 will now be described with reference to FIG. 9, FIG. 10, and FIG. 13.

The convergence of the first and second errors is determined (step SSV3).

It is determined to have converged in the case where the absolute value of the first error of the irradiation angle θy and the absolute value of the second error of the wavelength λ are not more than a predefined value (step SSV3: OK); and the flow proceeds to step SSV4. In the case where it has not converged (step SSV3: NG), the determination of step SSV3 is repeated.

The irradiation angle θy and the wavelength λ are maintained at the value at which it is determined to have converged in step SSV3 (step SSV4).

A hill-climbing control of the irradiation angle θx is performed to increase the luminance sum signal; and θx is maintained at the value at which the luminance sum signal is the maximum (step SSV5).

The control is completed; and at this point in time, the irradiation positions x and y, the irradiation angles θx and θy, and the wavelength λ of the reference beam RL2 for reproducing are the optimal values for reproducing.

After the readjustment of the irradiation angle θx (step SPO) illustrated in FIG. 6, the information reproduction apparatus 1 reaches the normal reproducing state; and the optimal reproducing state is maintained. In other words, the information reproduction apparatus 1 is in the state which is substantially satisfactory to obtain the recorded page data; and a control is performed to maintain this state.

Thus, according to the information reproduction apparatus 1, it is possible to control to the normal reproducing state using the first and second errors.

The information reproduction apparatus 1 controlled using the first and second errors has a configuration based on the following study regarding the luminance signal of the first light detector CCD1.

First, the detection of the first error and the control using the first error will be described.

FIG. 9 is a schematic view illustrating the reproduced luminance signal.

FIG. 9 illustrates the luminance signal of the information beam IL2 reproduced when changing the irradiation angles θx and θy of the reference beam RL2 with respect to the information recording medium HO. The temperature of the information recording medium HO when recording and the temperature of the information recording medium HO when reproducing are set to be equal.

The horizontal axis illustrates a first error Δθy between the irradiation angle θy1 of the reference beam RL1 for recording and the irradiation angle θy of the reference beam RL2 for reproducing equal to θy−θy1. The vertical axis illustrates a first error Δθx between the irradiation angle θx1 of the reference beam RL1 for recording and the irradiation angle θx of the reference beam RL2 for reproducing equal to θx−θx1.

The luminance signal (the luminance distribution) of the information beam IL2 reproduced for each is illustrated at the intersections of the first errors Δθx and Δθy. Because the irradiation angle θx1 is 0, Δθx=θx.

The y axis, i.e., the axis of the multiplex recording, is taken as the first axis; and the x axis, i.e., the axis perpendicular to the first axis, is taken as the second axis. The first error, i.e., the errors Δθx and Δθy of the angles, are the first error around the second axis and the first error around the first axis, respectively. As recited above, the first axis is the axis of the direction having the high angular selectivity and is the axis of the direction substantially orthogonal to the incident direction of the information beam IL1 for recording in the plane of the information recording medium HO. The second axis is the axis of the direction having the low angular selectivity.

The optimal reproducing state is when the first error Δθx=Δθy=0; and the entire luminance signal of the information beam IL2 output from the first light detector CCD1 is bright. The dark portions of the luminance signal increase as the absolute values of the first errors Δθx and Δθy increase. Although not illustrated, bit data represented by minute bright and dark areas are superimposed on the actual luminance signals.

The change of the luminance signal with respect to the first errors Δθx and Δθy illustrated in FIG. 9 has the two following properties.

Luminance signal property A:

(A1) The tilt of the luminance signal when approximated by a straight line is horizontal when the first error Δθy around the first axis is zero.

(A2) The direction of the change of the tilt of the luminance signal when approximated by a straight line when changing the irradiation angle θy of the reference beam RL2 around the first axis reverses depending on the polarity of the first error Δθx around the second axis.

In other words, by utilizing the property of (A1), the irradiation angle of the reference beam RL2 can be controlled to the ideal irradiation angle if the control unit 30 is operated such that the tilt of the luminance signal when approximated by the straight line becomes horizontal.

Similarly, by utilizing the property of (A2), the polarity of the first error Δθx around the second axis can be determined by detecting the direction of the change of the tilt of the luminance signal when approximated by the straight line when changing the irradiation angle θy of the reference beam RL2.

Although the horizontal state is used as the reference in the description recited above, the reference is an angle determined by the disposition angle of the first light detector CCD1 of the information reproduction apparatus 1, etc. In the case where the first light detector CCD1 is disposed oblique to the reproduced image of the page data, it is necessary also to modify the tilt of the reference from horizontal to oblique.

For example, in the example of the luminance signal illustrated in FIG. 9, when the first error Δθx around the second axis is positive, the tilt of the luminance signal when approximated by the straight line changes from −90 degrees (about −45 degrees in the drawing) to 90 degrees (about 45 degrees in the drawing) as the first error Δθy around the first axis increases. When the first error Δθx around the second axis is negative, the tilt of the luminance signal when approximated by the straight line changes from 90 degrees (about 45 degrees in the drawing) to −90 degrees (about −45 degrees in the drawing) as the first error Δθy around the first axis increases. Herein, the axis horizontal to the luminance signal has the angle of 0 degrees; and rotations in the counterclockwise direction are taken as the + direction.

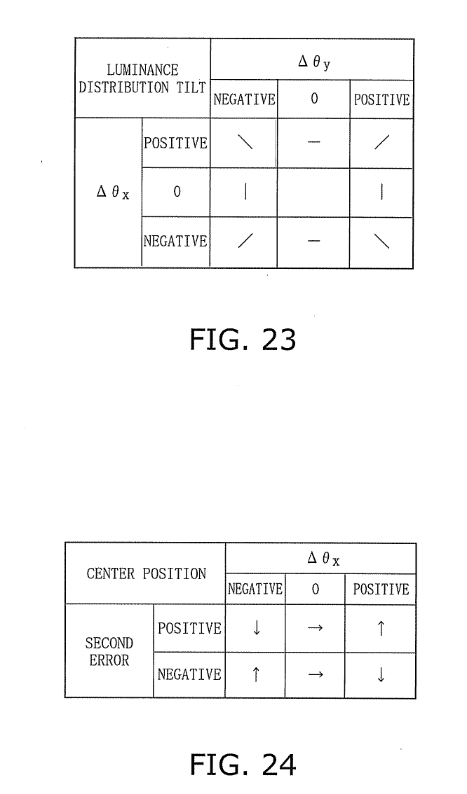

This is summarized in FIG. 23.

The columns of FIG. 23 illustrate the tilt of the luminance signal when approximated by the straight line when the first error Δθy around the first axis is negative, 0, and positive from left to right. The rows of FIG. 23 illustrate the tilt of the luminance signal when approximated by the straight line when the first error Δθx around the second axis is positive, 0, and negative from top to bottom.

In FIG. 23, the first error Δθy around the first axis is the first error around the multiplex axis as recited above.

FIG. 10 is another schematic view illustrating the reproduced luminance signal.

FIG. 10 illustrates the luminance signal of the information beam IL2 reproduced when the first errors Δθx and Δθy are changed in the case where the temperature of the information recording medium HO when reproducing is shifted from the temperature of the information recording medium HO when recording. In other words, other than the existence of the second error, this is similar to FIG. 9.

The dependency on the first errors Δθx and Δθy of the luminance signal reproduced in the case where the temperature of the information recording medium HO when reproducing is shifted from the temperature of the information recording medium HO when recording depends on the characteristics of the recording medium HO2 of the information recording medium HO. FIG. 10 is an example of simulation results.

As illustrated in FIG. 10, the luminance signal of the reproduced information beam IL2 has a circular ring configuration in the case where there is a second error and the temperature of the information recording medium HO when reproducing is shifted from the temperature of the information recording medium HO when recording. In this state as well, regarding the tilt of the straight line (the broken line in the drawing) when the circular-ring luminance distribution is approximated by a straight line, the change direction of the irradiation angle when changing the first error Δθy around the first axis is equal to that of the state of FIG. 9 and reverses depending on the polarity of the first error Δθx around the second axis.

In other words, also in the case of the example illustrated in FIG. 10, when the first error Δθx around the second axis is positive, the tilt of the straight line changes from −90 degrees to 90 degrees as the first error Δθy around the first axis increases. When the first error Δθx around the second axis is negative, the tilt of the straight line changes from 90 degrees to −90 degrees as the first error Δθy around the first axis increases. When the first error Δθx around the second axis is 0, the luminance signal is perpendicular; and the angle does not change depending on the first error Δθy around the first axis. Thus, the relationship illustrated in FIG. 23 holds even when the circular-ring luminance distribution occurs due to the temperature shift.

FIG. 10 illustrates the luminance signal of the information beam IL2 in the case where there is a second error and the temperature of the information recording medium HO when reproducing is shifted from the temperature of the information recording medium HO when recording. However, a circular-ring luminance distribution occurs similarly even in the case where there is a second error and the wavelength of the reference beam RL2 for reproducing is shifted from the wavelength of the reference beam RL1 for recording.

By utilizing the properties recited above, the control of the irradiation angle θy around the first axis can be performed as follows.

### Control B of Irradiation Angle θy:

(B1) The polarity of the first error Δθx around the second axis is discriminated.

(B1) The irradiation angle θy around the first axis is controlled to become horizontal by detecting the tilt of the luminance signal when approximated by a straight line.

In other words, the first error Δθy around the first axis can be detected by adding the polarity of the first error Δθx around the second axis to the tilt of the luminance signal when approximated by the straight line.

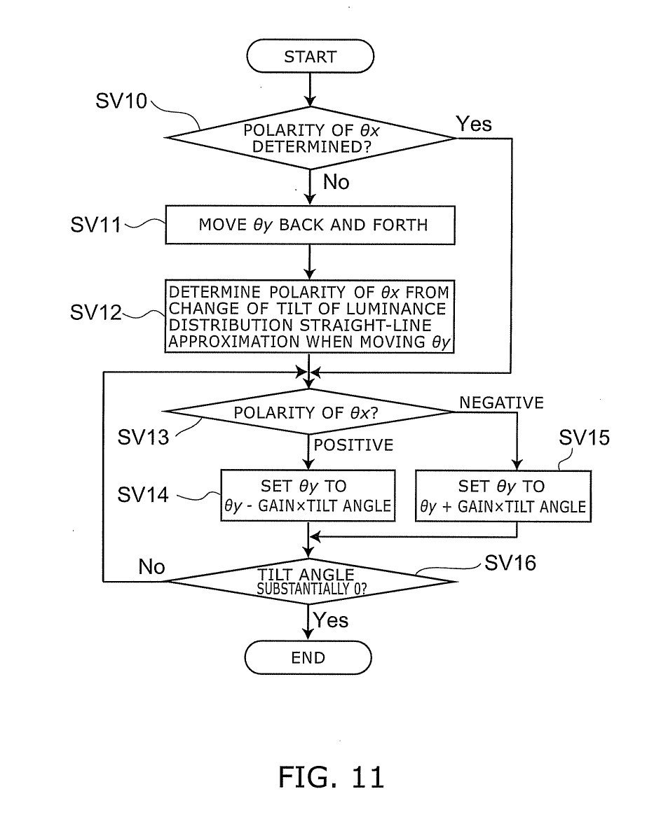

FIG. 11 is a flowchart of the angle control.

FIG. 11 is a flowchart of the angle control of the irradiation angles θx and θy of the reference beam RL2 for reproducing.

As illustrated in FIG. 11, first, it is determined whether or not the polarity of the first error Δθx around the second axis is determined (step SV10). As described in regard to FIG. 6, the polarity of the offset of the first error Δθx around the second axis is known after the initial pull-in operation is performed and the flow has proceeded to the servo operation.

In the case where the polarity of the first error Δθx around the second axis is determined (step SV10: Yes), the flow proceeds to step SV13.

In the case where the polarity of the first error Δθx around the second axis is undetermined (step SV10: No), the flow proceeds to step SV11 to discriminate the polarity of the first error Δθx around the second axis.

The irradiation angle θy around the first axis is moved back and forth (in the positive and negative directions) from the current value (step SV11).

The polarity of the first error Δθx around the second axis is discriminated from the change of the tilt of the straight-line approximation of the luminance signal when the irradiation angle θy around the first axis is moved (step SV12).

In other words, when the irradiation angle θy around the first axis is increased in the positive direction, the polarity of the first error Δθx around the second axis can be discriminated to be positive in the case where the tilt of the straight-line approximation increases (step SV13: Positive). When the irradiation angle θy around the first axis is increased in the positive direction, the polarity of the first error Δθx around the second axis can be discriminated to be negative in the case where the tilt of the straight-line approximation decreases (step SV13: Negative).

When the polarity of the first error Δθx around the second axis is positive, the irradiation angle θy around the first axis is corrected to be θy−gain×tilt angle (step SV14). When the polarity of the first error Δθx around the second axis is negative, the irradiation angle θy around the first axis is corrected to be θy+gain×tilt angle (step SV15).

Then, it is determined whether or not the tilt angle of the straight-line approximation of the luminance signal is zero. In the case where it is not zero, the flow returns to step SV13; and the processing is repeated (step SV16: No).

In the case where the tilt angle of the straight-line approximation of the luminance signal is zero, the control of the irradiation angle θy around the first axis ends (step SV16: Yes).

As described below, after a wavelength correction using the second error is performed, there are many cases where the first error Δθx around the second axis greatly shifts. However, even in the case where the first error Δθx around the second axis is shifted and the luminance signal of the reproduced information beam IL2 has a circular ring configuration or a rod configuration, it is possible to adjust to the optimal irradiation angle θy around the first axis by detecting the tilt of the luminance signal. Because the feedback control uses the tilt of the luminance signal as the target value, it is possible to converge to the optimal irradiation angle θy around the first axis faster than by the hill-climbing method if the servo gain is set appropriately.

The detection of the second error and the control using the second error will now be described.

Namely, this is the case where there is a wavelength error of the reference beam RL2 and there is a temperature error due to the temperature of the information recording medium HO when reproducing being shifted from the temperature of the information recording medium HO when recording.

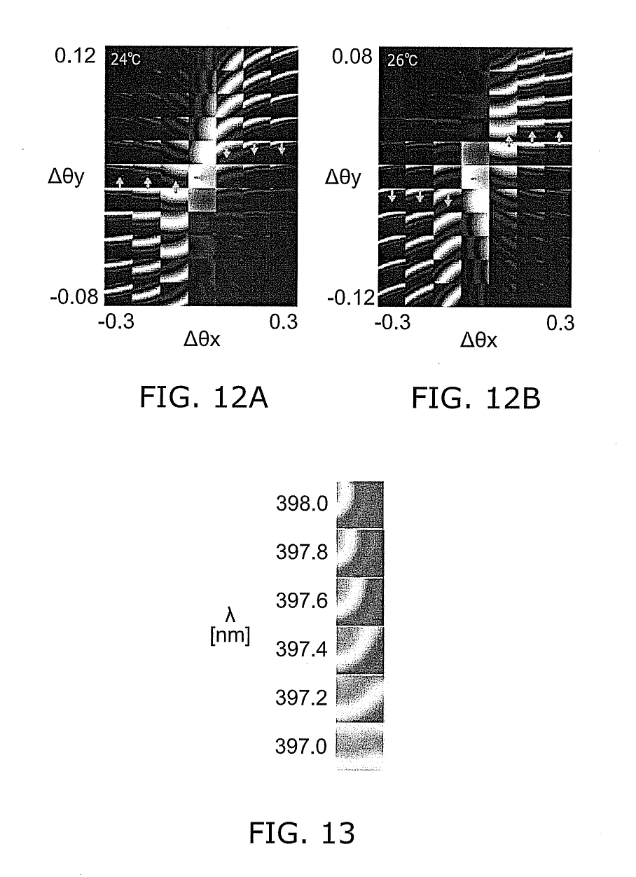

FIGS. 12A and 12B are other schematic views illustrating the reproduced luminance signal.

FIGS. 12A and 12B illustrate the luminance signal of the information beam IL2 reproduced when changing the irradiation angles θx and θy for cases where the temperature of the information recording medium HO when recording is 25° C. and the temperature when reproducing is different from that of the recording. FIG. 12A illustrates the case where the temperature when reproducing is 24° C.; and FIG. 12B illustrates the case where the temperature when reproducing is 26° C. It is taken that there is no wavelength error.

The horizontal axis illustrates the first error Δθx between the irradiation angle θx1 of the reference beam RL1 for recording around the second axis and the irradiation angle θx of the reference beam RL2 for reproducing around the second axis equal to θx−θx1. The vertical axis illustrates the first error Δθy between the irradiation angle θy1 of the reference beam RL1 for recording around the first axis and the irradiation angle θy of the reference beam RL2 for reproducing around the first axis equal to θy−θy2. The luminance signal of the information beam IL2 reproduced at this time is illustrated at the intersections of Δθx and Δθy. Because the irradiation angle θx1 around the second axis of the reference beam RL1 for recording equals 0, the first error Δθx around the second axis equals θx.

The arrows of FIGS. 12A and 12B illustrate the direction of the center position when the circular-ring luminance distribution occurring due to the second error between the temperature of the information recording medium HO when recording and the temperature of the information recording medium HO when reproducing is approximated by a circle. Although this direction depends on the first error Δθx around the second axis being positive or negative, the orientation is constant according to the direction in which the temperature is shifted.

The dependency on the first errors Δθx and Δθy of the luminance signal reproduced in the case where there is a second error depends on the characteristics of the recording medium HO2 of the information recording medium HO. FIGS. 12A and 12B illustrate simulation results of the case where the best reproduction wavelength is shorter if the temperature when reproducing is higher than when recording.

When the first error Δθx around the second axis is zero, the direction of the center position of the circle does not depend on the direction of the wavelength shift. Therefore, in the case where the first error Δθx around the second axis is determined to be substantially zero when discriminating the polarity of the first error Δθx around the second axis, the irradiation angle θx around the second axis is provided with a slight offset. Thus, it can be discriminated which direction to change the wavelength of the reference beam RL2 by observing the direction of the center position of the circular ring and whether the first error θx around the second axis is positive or negative.

This is summarized in FIG. 24.

The columns of FIG. 24 illustrate the center position when the luminance signal is approximated by a circular ring when the first error Δθx around the second axis is negative, 0, and positive from left to right. The rows of FIG. 24 illustrate when the second error is positive (the case where the temperature when reproducing is higher than the temperature when recording) and negative (the case where the temperature when reproducing is lower than the temperature when recording) from top to bottom. The center position is illustrated by the arrows that show whether the center position is above or below the approximated circular ring.

As illustrated in FIG. 24, in the case where the first error Δθx around the second axis is positive, the center position is above the luminance signal approximated by the circular ring in the case where the temperature of the information recording medium HO when reproducing is higher than the temperature of the information recording medium HO when recording. In the case where the temperature when reproducing is lower than the temperature when recording, the center position is below the luminance signal approximated by the circular ring. In the case where the first error Δθx around the second axis is negative, this vertical relationship is reversed.

In the case of the information recording medium HO illustrated in FIGS. 12A and 12B, the case where the temperature when reproducing is higher than the temperature when recording corresponds to the wavelength of the optimal reference beam RL2 being shifted to be longer. Similarly, the case where the temperature when reproducing is lower than the temperature when recording corresponds to the wavelength of the optimal reference beam RL2 being shifted to be shorter.

However, as recited above, this relationship depends on characteristics of the recording medium HO2 of the information recording medium HO such as the coefficient of thermal expansion.

FIG. 13 is another schematic view illustrating the reproduced luminance signal.

FIG. 13 illustrates the luminance signal of the information beam IL2 reproduced when changing the wavelength λ of the reference beam RL2 in the case where the temperature of the information recording medium when recording is 25° C. and the temperature when reproducing is 50° C. As recited above, the wavelength dependency of the luminance signal depends on the characteristics of the recording medium HO2 of the information recording medium HO. FIG. 13 is an example of simulation results.

As the shift quantity of the wavelength λ of the reference beam RL2 for reproducing decreases, the radius when the circular-ring luminance distribution is approximated by a circle gradually increases and becomes substantially a straight line in the state in which the wavelength is optimal (397.0 nm).

Thus, if the direction of the first error Δθx around the second axis is determined, the direction of a wavelength shift Δλ (the orientation of the circular ring) and a quantity (the reciprocal of the radius of the circular ring or the center coordinates) that is proportional to the shift quantity can be obtained from the feature extraction quantity of the reproduced information beam IL2. In other words, the second error can be detected; and the wavelength λ of the reference beam RL2 can be controlled based on the second error.

From the description recited above, the following two properties can be stated.

### Luminance Signal Property C:

(C1) Although the direction of the center position when the circular-ring luminance distribution is approximated by a circle depends on the polarity (positive or negative) of the first error Δθx around the second axis, the orientation is constant according to the direction in which the wavelength λ of the reference beam RL2 shifts if the polarity of the first error Δθx is constant.

(C2) As the shift quantity of the wavelength λ decreases, the radius when the circular-ring luminance distribution is approximated by the circle gradually increases and becomes substantially a straight line in the state in which the wavelength is optimal.

In other words, by utilizing the property of (C1), the wavelength of the reference beam RL2 can be controlled to the ideal wavelength if the wavelength of the reference beam RL2 is changed such that the center position when the circular-ring luminance distribution is approximated by the circle becomes the reference position.

By utilizing the property of (C2), the wavelength of the reference beam RL2 can be controlled to the ideal wavelength if the wavelength of the reference beam RL2 is changed such that the reciprocal (the curvature) of the radius when the circular-ring luminance distribution is approximated by the circle becomes 0.

Here, the reference position is determined by the disposition of the components of the information reproduction apparatus. For example, in the case of the information reproduction apparatus 1, the ideal reproducing state is the state in which the entire image region is bright as illustrated by the central portion of FIG. 9, that is, the center of the reproduced image of the page data matches the center of the luminance signal. In such an apparatus, the reference position can be set to be the center of the luminance signal. Also, the reference position may be the peak position of the distribution of the luminance signal.

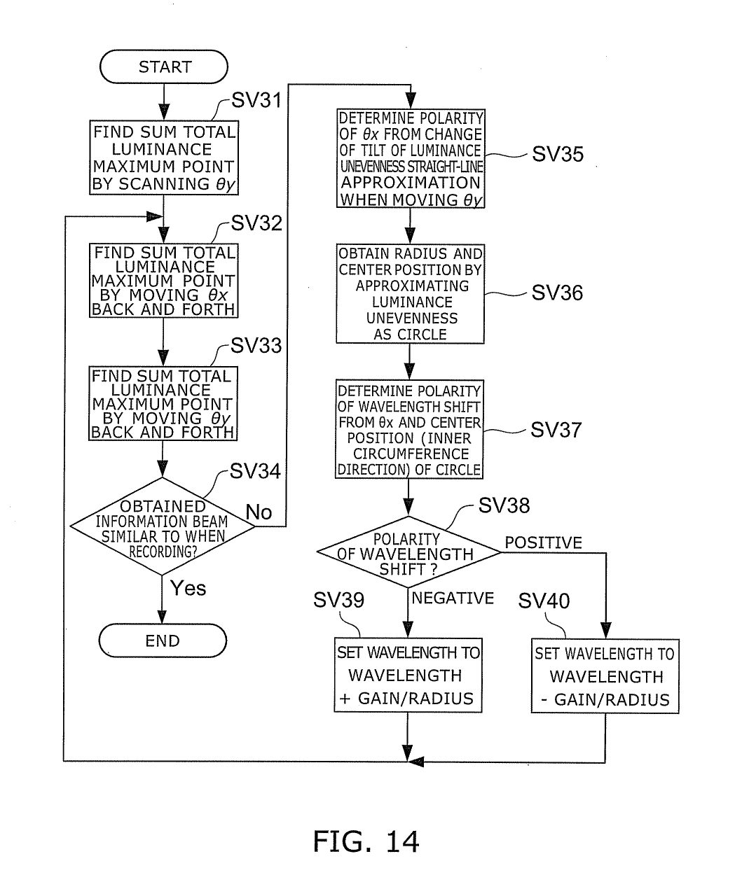

FIG. 14 is a flowchart of the wavelength control.

FIG. 14 illustrates a method for controlling the wavelength of the reference beam RL2 by utilizing the properties recited above.

First, if the flow starts from the state in which the information beam IL2 cannot be obtained at all, the irradiation angle θy around the first axis of the reference beam RL2 is scanned to reach the state in which some information beam IL2 is obtained (step SV31).

Then, the irradiation angle θx around the second axis is set to be the optimal value (the luminance signal sum maximum point) at that point in time (step SV32).

Subsequently, the irradiation angle θy around the first axis is set to be the optimal value (the luminance signal sum maximum point) (step SV33).

At this point in time, in the case where it has been determined that the optimal reproducing state has been reached, the processing ends without performing the correction of the wavelength λ; and the flow proceeds to the normal reproducing state (step SV34: Yes).

In the case where it is determined that the optimal reproducing state has not been reached, the flow proceeds to the subsequent step SV35 (step SV34: No).

The processing of steps SV31 to SV34 recited above is similar to the pull-in operation (step SPR) described in regard to FIGS. 5A to 5C and FIG. 6.

The processing of the wavelength control is performed from step SV35.

The polarity of the first error Δθx around the second axis is discriminated (step SV35). In other words, the polarity of the first error Δθx around the first axis is inferred from the change of the tilt angle of the luminance signal when approximated by the straight line when the first error Δθy around the second axis is moved.

The center position and the radius when the luminance signal is approximated by the circle are obtained (step SV36).

The direction of the temperature shift (the wavelength shift) is inferred from the center position of the circle (the direction of the inner circumference) and the inferred polarity of the first error Δθx around the second axis (step SV37).

Thereby, the polarity of the wavelength correction is determined; and the wavelength λ is controlled such that the curvature (the reciprocal of the radius) of the approximated circle becomes 0 (steps SV38 to SV40).

In other words, in the case where the polarity of the wavelength shift is determined to be negative (step SV38: Negative), the wavelength λ is corrected by being set to λ+gain/radius (step SV39). Then, the flow returns to step SV32; and the processing is repeated.

In the case where the polarity of the wavelength shift is determined to be positive (step SV38: Positive), the wavelength λ is corrected by being set to λ−gain/radius (step SV40). Then, the flow returns to step SV32; and the processing is repeated.

In other words, the second error is an error in which the polarity of the wavelength shift is added to the reciprocal of the radius when the luminance distribution of the reproduced information beam IL2 is approximated by the circle.

As recited above, because the temperature dependency and the wavelength dependency of the luminance signal depend on the characteristics of the recording medium HO2 of the information recording medium HO, the polarity of the wavelength shift also depends on the recording medium HO2.

Thus, the wavelength control of the information reproduction apparatus 1 is one type of feedback control that uses the center coordinates or the curvature of the approximated circle as a target value. Therefore, it is possible to reliably control to the appropriate wavelength λ if the extraction of the feature extraction quantity and the setting of the feedback gain are performed appropriately using the image analysis of the luminance signal. In the case where only the wavelength λ is moved with the irradiation angles θx and θy fixed as-is, there are cases where the reproduced information beam IL2 jumps out of the detection range of the first light detector CCD1 and cannot be detected.

Therefore, in FIG. 14, the search (hill climbing) for the sum total luminance maximum value of the irradiation angles θx and θy is included in the repeated routine. However, this is performed for convenience to keep the reproduced information beam IL2 inside the detection range of the first light detector CCD1. Accordingly, if a configuration is used to move the irradiation angles θx and θy such that the irradiation angles θx and θy do not vanish from the detection range of the first light detector CCD1, it is unnecessary to use hill climbing; and it is unnecessary for this to be performed every time if the reproduced information beam IL2 is inside the detection range.

In other words, the flow may return to step SV35 from each of steps SV39 and SV40; and the processing may be repeated.

Thus, in the information reproduction apparatus 1, the feature extraction quantity is extracted from the luminance signal of the reproduced information beam IL2 converted into the electrical signal by the first light detector CCD1. The first error and the second error are detected from the feature extraction quantity. The normal reproducing state can be reached by controlling the irradiation angle and the wavelength of the second reference beam using the first and second errors.

This control is performed at a high speed using feedback control. Also, stable control is possible by appropriately setting the servo gain.

The second error can be corrected by controlling the wavelength of the reference beam RL2 without measuring the temperature of the information recording medium HO.

However, it is also possible to control the wavelength λ of the reference beam RL2 by measuring the temperature when reproducing the information recording medium HO. A configuration that controls the temperature when reproducing also is possible.

The control of the irradiation angles θx and θy using the first error and the control of the wavelength λ using the second error are described in regard to FIG. 11 and FIG. 14, respectively. However, it is also possible to perform these two controls simultaneously.

FIG. 15 is another schematic view illustrating the reproduced luminance signal.

FIG. 15 schematically illustrates the luminance signal of the information beam IL2 reproduced when changing the wavelength λ and the irradiation angle θy around the first axis (the multiplex axis) of the reference beam by a constant step. This is an example of a simulation in the case where the temperature of the information recording medium HO when reproducing is equal to the temperature when recording.

The thickness of the recording medium HO is 1 mm; the offset of the irradiation angle θx around the second axis is −0.5 degrees; and the irradiation angle θy around the first axis when recording is −10 degrees. A wavelength λ1 when recording is 405 nm; and the recording and the reproducing are at the same temperature.

The horizontal axis illustrates the change of the irradiation angle θy around the first axis of the reference beam RL2; and the vertical axis illustrates the wavelength λ (μm) of the reference beam RL2.

The subdivided quadrilateral blocks at the intersections of θy and λ illustrate the luminance signal reproduced at the wavelength λ and the irradiation angle θy around the first axis.

In FIG. 15, the luminance signal of the center where θy=−10 and λ=0.405 is the luminance signal when the values of the wavelength and the irradiation angle around the first axis just match between the recording and the reproducing. Because the offset is provided to the irradiation angle θx around the second axis, the luminance signal is fine and has a rod configuration.

Observing now the case where the irradiation angle θy around the first axis is changed when the wavelength λ of the reference beam RL2 is constant, that is, in order in the lateral direction of FIG. 15, it can be seen that the angle of the straight line of the luminance signal having the rod configuration rotates in the clockwise direction. The change of this angle extracted from the luminance signal becomes the first error Δθy around the first axis.

On the other hand, observing now the case where the wavelength λ is changed in order in the vertical direction near where the irradiation angle θy around the first axis matches the irradiation angle θy1 when recording, that is, near where θy=−10 degrees, i.e., the central portion of FIG. 15, it can be confirmed that the angle of the rod configuration of the luminance signal changes while the rod configuration becomes curved from the center toward the outside.

This is an upward arc in the case where the wavelength λ when reproducing is shorter than the wavelength λ1 when recording (the upper portion of FIG. 15). This is a downward arc in the case where the wavelength λ when reproducing is longer than the wavelength λ1 when recording. As recited above, the second error signal is the signal in which such changes of the radius or the curvature of the arc and the orientation of the center coordinates of the arc of the luminance signal are detected.

FIG. 16 is a graph illustrating the output of the error detection unit.

FIG. 16 is a contour diagram illustrating the appearance of the change of the first error Δθy around the first axis when changing the wavelength λ and the irradiation angle θy around the first axis by the same step as that of FIG. 15.

As illustrated in FIG. 16, the first error around the first axis is zero in the state in which the wavelength and the irradiation angle θy around the first axis are matched between the recording and the reproducing.

As the irradiation angle θy around the first axis increases, the first error Δθy around the first axis also increases. As the irradiation angle θy around the first axis decreases, the first error Δθy around the first axis also decreases.

Such a state in which the contours of the first error Δθy around the first axis are arranged perpendicular to the change of the irradiation angle θy around the first axis, which is the control axis, is suitable for controlling.

In the information reproduction apparatus 1 illustrated in FIG. 1, the irradiation angle θy around the first axis is controlled based on the first error Δθy around the first axis. The irradiation angle θy around the first axis can be maintained at a constant during normal reproducing.

On the other hand, observing now the change of the contour for which the first error Δθy around the first axis is zero when the wavelength λ is changed, it can be confirmed that the value of the irradiation angle θy around the first axis at which the first error Δθy around the first axis is zero is shifted from −10 degrees, which is the irradiation angle Δθ1 when recording.

This means that an offset occurs in the control signal of the first error Δθy around the first axis when reproducing in the case where the wavelength is shifted between the recording and the reproducing. Accordingly, in the case where the wavelength is shifted between the recording and the reproducing, the irradiation angle θy around the first axis cannot be matched between the recording and the reproducing, that is, the complete reproduced image unfortunately cannot be obtained, even in the case where the first error around the first axis such as that illustrated in FIG. 14 is utilized.

FIG. 17 is another graph illustrating the output of the error detection unit.

Similarly to FIG. 16, FIG. 17 is a contour diagram illustrating the appearance of the second error, i.e., the change of wavelength error, when changing the wavelength λ and the irradiation angle θy around the first axis.

As illustrated in FIG. 17, the second error is zero in the state in which the wavelength λ and the irradiation angle θy around the first axis are matched between the recording and the reproducing.

Near where the irradiation angle θy around the first axis is 0, the second error increases as the wavelength λ increases. As the wavelength λ decreases, the second error also decreases.

Accordingly, in the information reproduction apparatus 1 illustrated in FIG. 1, the irradiation angle θy around the first axis can be maintained at a constant by controlling the irradiation angle θy around the first axis based on the second error.

On the other hand, as illustrated in FIG. 17, the range in which the contours of the second error are arranged perpendicular to the change of the wavelength λ, which is the control axis, is limited to a narrow range of the irradiation angle θy around the first axis. In the state in which the irradiation angle θy around the first axis when reproducing is greatly shifted from the value of θy1 when recording, i.e., the states of the right edge and the left edge of FIG. 17, the wavelength λ (the position) at which the second error is zero is a value greatly offset from the wavelength λ1 when recording of 405 nm.

Particularly at the left edge, the state in which the second error is zero no longer exists. The normal control of the wavelength λ cannot be implemented in such a dead zone.

Thus, the first error Δθy around the first axis and the second error interfere with each other; and the control thereof cannot be converged to the optimal value of the irradiation angle θy around the first axis or the optimal wavelength λ when reproducing even when one of these is shifted.

Accordingly, there are cases where it is not possible to converge when the control of the irradiation angle θy using the first error Δθy described in regard to FIG. 11 and the control of the wavelength λ using the second error described in regard to

FIG. 14 are performed independently from each other.

Therefore, it is possible to ultimately converge to the state in which neither the irradiation angle θy nor the wavelength λ are offset by controlling the irradiation angle θy and the wavelength λ simultaneously or alternately.

Returning again to FIG. 6, in the servo operation (step SSV), the control of the irradiation angle θy and the wavelength λ using the first and second errors is performed simultaneously or alternately.

FIG. 8 illustrates the control of the irradiation angle θy using the first error Δθy being performed simultaneously to the control of the wavelength λ using the second error.

The control unit 30 controls such that the convergence of the irradiation angle θy is faster than that of the wavelength λ.

Therefore, the control of the irradiation angle θy and the control of the wavelength λ are operated along the contour where the first error Δθy equals 0. As a result, the effect of the dead zone of the second error is avoided; and it is possible to stably converge both.

After controlling to the optimal reproducing state in the information reproduction apparatus 1 as recited above, a control to maintain the normal reproducing state is performed. In other words, the state which is substantially satisfactory to obtain the recorded page data is reached; and the control to maintain this state is performed.

The control from the state in which the luminance signal of the reproduced information beam IL2 recited above cannot be obtained to the state in which the luminance signal of the reproduced information beam IL2 can be obtained can be applied also to normal reproducing. In other words, the state is maintained in which the irradiation angle θx around the second axis is offset slightly enough to not affect the reproduction of the page data; and a feedback control is performed by detecting the second error and the first error Δθy around the first axis.

A method will now be described for controlling to a state in which the polarity of the first error Δθx around the second axis is maintained to be one polarity or the other by offsetting the irradiation angle θx around the second axis in normal reproduction.

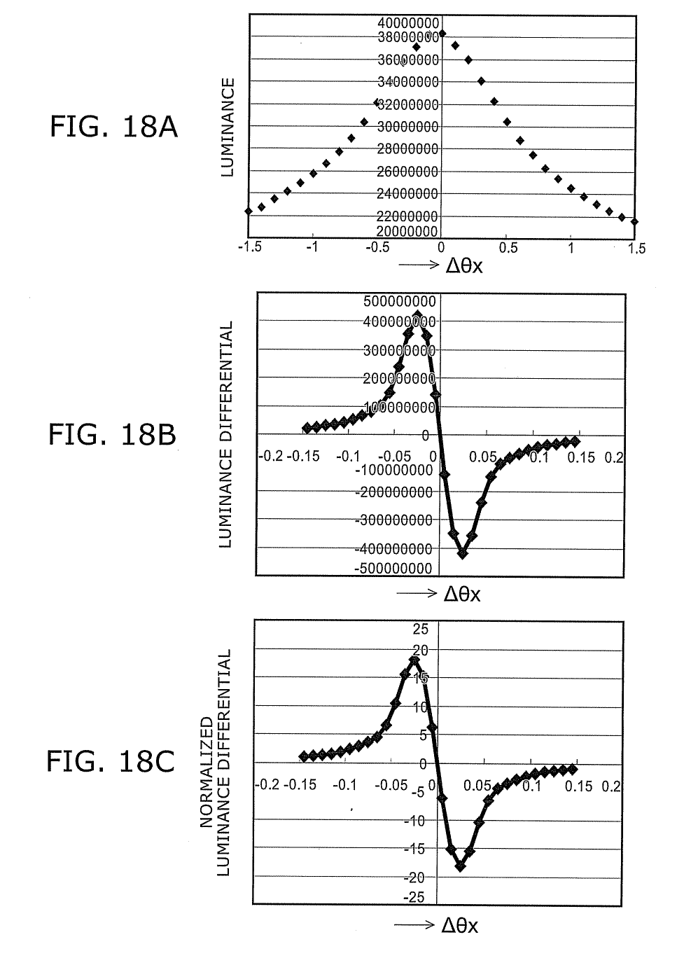

FIGS. 18A to 18C are graphs illustrating the detection process of the angle error in normal reproduction.

FIG. 18A illustrates the luminance signal sum (the sum total luminance) of the information beam IL2 reproduced when changing the first error Δθx around the second axis according to a simulation. FIG. 18B illustrates the differential of the sum total luminance illustrated in FIG. 18A. FIG. 18C illustrates the differential of the sum total luminance normalized by the sum total luminance maximum value.

As illustrated in FIG. 18B, the differential of the sum total luminance with respect to the first error Δθx around the second axis changes monotonously near where the first error Δθx around the second axis is zero (between −0.03 to 0.03 degrees). By utilizing this property, the state in which the first error Δθx around the second axis is minutely shifted (offset) within the range of the first error Δθx around the second axis where the differential changes monotonously can be maintained if the control is performed to maintain the differential of the sum total luminance at a constant. It is favorable to use the differential normalized by the sum total luminance maximum value to exclude the effects of the luminance fluctuation of the light source ECLD, etc. (FIG. 18C).

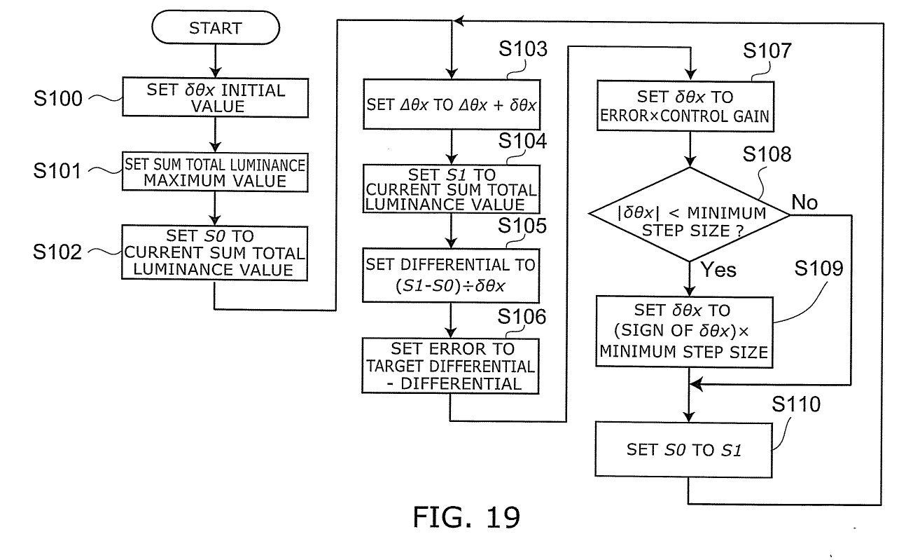

FIG. 19 is a flowchart of the angle control in normal reproduction.

FIG. 19 is a flowchart that maintains the state in which the first error Δθx around the second axis is minutely offset by utilizing the properties recited above.

The differential of the sum total luminance with respect to the first error Δθx around the second axis can be determined from the difference of the sum total luminance when minutely moving the first error Δθx around the second axis. For example, the differential can be obtained by finding the differences of each of the sum total luminance and the first error Δθx around the second axis from those of one sample previous and by dividing. Or, the differential can be obtained by dividing the difference of the sum total luminance by an increment δθx of the first error Δθx around the second axis.

First, the initial value of the increment δθx of the first error Δθx around the second axis is set (step S100). The increment δθx is the unit used when calculating the differential using the difference.

The maximum value of the sum total luminance is set (step S101). For the maximum value of the sum total luminance, the maximum value of the sum total luminance of the leading information recording medium multiplexed using a separate initial adjustment, etc., is set.

S0 is set to the current sum total luminance value (step S102).

The first error Δθx around the second axis is renewed to be Δθx+δθx (step S103).

S1 is set to the current sum total luminance value (step S104). S0 is the sum total luminance value of one sample previous.

The differential is calculated by (S1−S0)/δθx (step S105).

The error of the first error Δθx around the second axis is determined by the target differential minus the calculated differential (step S106).

The corrected quantity of the increment δθx is set to be the error of the first error Δθx around the second axis calculated by step S106 multiplied by the control gain (the servo gain) (step S107).

It is determined whether or not the increment δθx is smaller than the minimum step size. If smaller (step S108: Yes), the increment δθx is set to the minimum step size (step S109). If larger, the flow proceeds as-is to the next step S110.

This is because the correct differential can no longer be obtained when the movement quantity δθx of the first error Δθx around the second axis is too minute. Even if the target value is achieved, Δθx is moved by the predefined minimum step size.

The sum total luminance value S0 of one previous is renewed to be the current sum total luminance value of S1; the flow returns to step S103; and the processing is repeated (step S110).

By repeating the processing of steps S103 to S110, the state in which the first error Δθx around the second axis is minutely offset can be maintained.

Although not described in FIG. 19 for simplification, it is necessary to confirm whether or not the first error Δθx around the second axis is within the range where the differential of the sum total luminance changes monotonously; and it is necessary to perform a recovery processing in the case where the first error Δθx around the second axis is outside the range. Further, it is necessary to adjust the servo gain to the appropriate value.

Thus, by minutely offsetting the first error Δθx around the second axis, the second error and the first error Δθy around the first axis can be detected by the error detection unit.

However, it is necessary to approximate the luminance signal by a straight line or a circle to detect the first and second errors from the reproduced information beam IL2.

A method for extracting the feature extraction quantity of the tilt of the straight line or the radius, the center, etc., of the circle from the luminance signal will now be described.

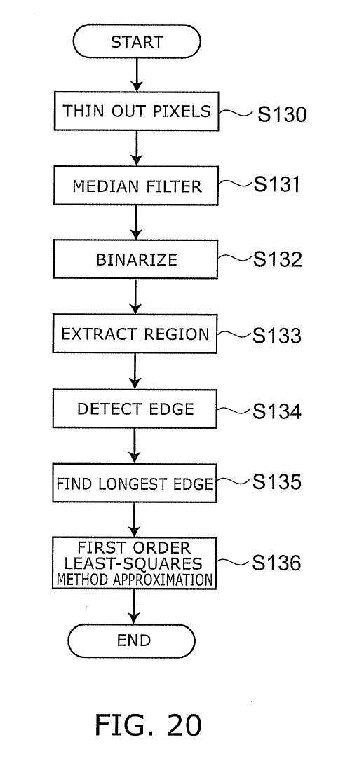

FIG. 20 is a flowchart that extracts the feature extraction quantity from the luminance signal.

FIG. 20 illustrates a method that uses the edge (the border of the bright and dark) of the luminance signal as an example of a method for approximating the luminance signal of the reproduced information beam IL2 by a straight line or a circle (to obtain a feature quantity).

Steps such as those recited below are performed.

The luminance signal from the first light detector CCD1 is thinned out (step S130). This is to reduce the amount of processing because not all of the data of the luminance signal is necessary to detect the first and second errors.

The noise components are removed while maintaining the edge information as-is by performing median filter processing (step S131).

Binarization is performed (step S132). Various methods for determining the threshold value are possible. For example, the average of the maximum value and the minimum value of the luminance signal may be used as the threshold value.

A region extraction is performed (step S133). Labeling, etc., is performed as pre-processing to recognize a lumped group of adjacent points as one region and discriminate the continuous regions from each other.

Edge detection is performed (step S134). For example, the edge is obtained by extracting the luminance gradient of each of the lateral direction and the vertical direction using a Sobel operator and calculating the root mean square (RMS) thereof.

The longest edge (the edge for which the distance between the pixels included in one continuous edge is the longest) is found (step S135).

The equation of a straight line or a circle is obtained by applying the least-squares method to the found edge (step S136).

Although flowchart illustrated in FIG. 20 illustrates the case where the edge of the luminance signal is used, it is also possible to use a method for detecting the ridge of the luminance signal.

As another method for detecting the tilt of the straight line and the curvature of the circle, it is also possible to utilize a method that does not detect using an approximation equation. For example, a method may be used in which the luminance signal is segmented into multiple regions and the difference of the sum of the luminance inside each of the regions is detected.

For example, for a luminance signal such as that illustrated in FIG. 9, the luminance signal of each of the conditions is segmented into the triangular region of the lower right and the triangular region of the upper left. The sum total of the luminance signal inside the regions is taken as a first sum total and a second sum total respectively. The tilt of the straight line can be detected by the difference of the first sum total and the second sum total.

For example, for the conditions of the first error Δθy around the first axis being 0.03 and the first error Δθx around the second axis being 0.03, the first sum total has a large value and the second sum total has a small value. In other words, the difference signal increases on the plus side. On the other hand, for the conditions of the first error Δθy around the first axis being 0 and the first error Δθx around the second axis being 0.03, the first sum total matches the second sum total; and the difference signal becomes 0. For the conditions of the first error Δθy around the first axis being −0.03 and the first error Δθx around the second axis being 0.03, the first sum total has a small value and the second sum total has a large value. In other words, the difference signal increases on the minus side.

Thus, the tilt of the straight line can be obtained also by a method using region segmentation of the luminance signal.

However, because it is sufficient to obtain the feature extraction quantity of the luminance signal when acquiring the servo error information using the image, that is, when detecting the first and second errors, a high-resolution imaging device is unnecessary. In the case of a high-resolution imaging device, extra processing is necessary to thin out while averaging the aggregate of the points included in the page data.

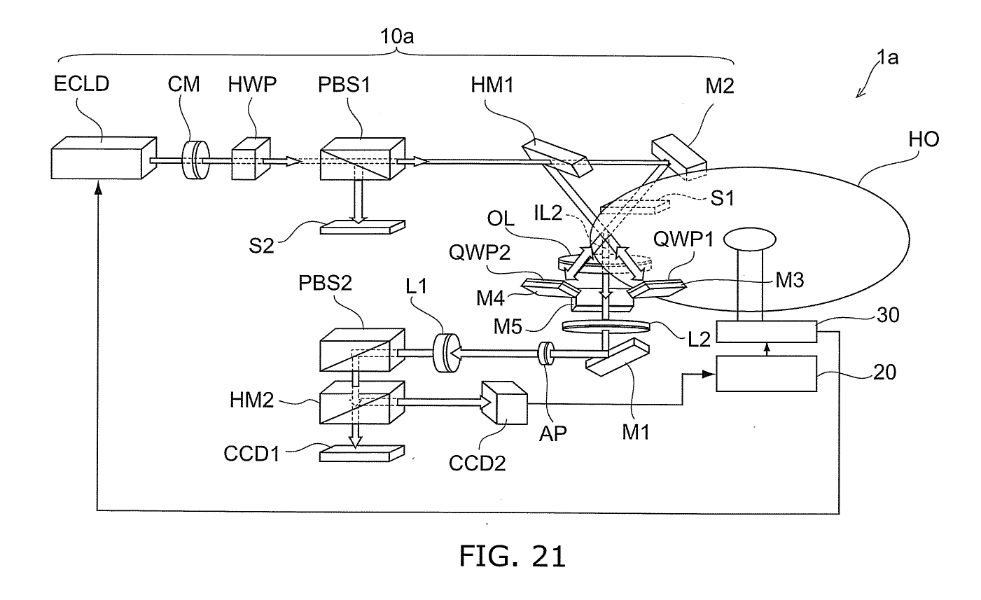

FIG. 21 is a schematic perspective view of the information reproduction apparatus according to another embodiment.

As illustrated in FIG. 21, the information reproduction apparatus is differs from the information reproduction apparatus 1 in that a half mirror HM2 and a second light detector CCD2 for the servos are further included.

In other words, in the information reproduction apparatus 1a, the second light detector CCD2, which is a low-resolution imaging device for acquiring servo information, is provided separately from the first light detector CCD1, which is the high-resolution imaging device for the page data.

The reproduced information beam IL2 is split into two by the half mirror HM2. One branch of the information beam IL2 is irradiated onto the first light detector CCD1. The other branch is irradiated onto the second light detector CCD2.

The first light detector CCD1 illustrated in FIG. 21, which is the high-resolution imaging device for the page data, is similar to the first light detector CCD1 illustrated in FIG. 1. For example, the sampling frequency of the servo system is set to 1 kHz. In such a case, a transfer rate and a processing capability of the arithmetic circuit of 3.24 GBytes/s is necessary in the case where the resolution of the imaging device for acquiring page data is 1800×1800 pixels. Here, 1 pixel is taken to be 1 byte. Conversely, for example, 76.8 MBytes/s is necessary when using a QVGA (320×240 pixels) servo imaging device as the second light detector CCD2. This is on the order of the processing possible using digital circuit technology.

The low-resolution imaging device for acquiring servo information is advantageous from the aspect of the SN ratio as well because reducing the resolution allows the sensitivity of the imaging device to be increased easily which is suited to high-speed imaging. FIG. 22 illustrates a configuration in which imaging devices are used as the first and second light detectors CCD1 and CCD2. However, the details of the devices are arbitrary as long as the two-dimensional strength of the light can be captured; and a CMOS image sensor, a PD (photodiode) array, etc., may be used.

The recording is possible by the information recording medium HO having a configuration substantially similar to that of the information reproduction apparatus 1 illustrated in FIG. 1.

FIG. 22 is a schematic perspective view when recording the information recording medium.

In the case of recording the information recording medium HO as illustrated in FIG. 22, a λ/4 plate QWP3 and a spatial modulator SLM are further provided rearward of the polarizing beam splitter PBS2 in the information reproduction apparatus 1.

During the recording, the shutter S2 is open; and the light branching in the downward direction due to the polarizing beam splitter PBS1 is reflected by the polarizing beam splitter PBS2, passes through the rearward λ/4 plate QWP3, and is irradiated onto the spatial modulator SLM.

The spatial modulator SLM spatially modulates the strength of the irradiated light with the page data to be recorded and reflects the result as the information beam IL1. Here, as recited above, the page data is two-dimensionally arranged binary data. For example, the spatial modulator SLM may have a configuration in which a reflective film is provided to reflect the irradiated light according to the page data.

From the spatial modulator SLM, the spatially-modulated information beam IL1 again passes through the λ/4 plate QWP3 and passes through the polarizing beam splitter PBS2 in the lateral direction.

The information beam IL1 passing through and being reflected by the lens L1, the aperture AP, the mirror M1, and the lens L2 in this order is reflected by the reflect mirror M5 in the reverse direction of that when reproducing, passes through the objective lens OL, and is irradiated onto the information recording medium HO.

On the other hand, similarly to the reproducing, the reference beam passing through the polarizing beam splitter PBS1 in the lateral direction is split into the reference beams RL1a and RL1b by the half mirror HM1 and the mirror M2. The reference beams RL1a and RL1b are the reference beam RL1 when performing multiplex recording of the information in the information recording medium HO.

The reference beam RL1a passes through the information recording medium HO, which is the information recording medium, from below. The reference beam RL1a is irradiated onto the same location on the information recording medium HO where the information beam IL1 to be recorded is irradiated. During the recording, the λ/4 plate QWP1 and reproduction mirror M3 are unnecessary. In the case of a configuration similar to that of the reproduction, the reference beam RL1a passing through the medium is prevented from returning to the medium by disposing a not-illustrated shutter in front of the λ/4 plate QWP1 or by performing an operation such as changing the angle of the reproduction mirror M3.

The reference beam RL1b also passes through the information recording medium HO. The reference beam RL1b is irradiated onto the same location on the information recording medium HO where the information beam IL1 to be recorded is irradiated. During the recording, the λ/4 plate QWP2 and the reproduction mirror M4 are unnecessary. In the case of a configuration similar to that of the reproduction, the reference beam RL1b passing through the medium is prevented from returning to the medium by disposing a not-illustrated shutter in front of the λ/4 plate QWP2 or by performing an operation such as changing the angle of the reproduction mirror M4.

When recording information, one selected from the reference beam RL1a and the reference beam RL1b is optically shielded constantly by the shutter S1. The reference beam RL1a and the information beam IL1 are irradiated simultaneously onto the same location on the information recording medium HO; or the reference beam RL1b and the information beam IL1 are irradiated simultaneously onto the same location on the information recording medium HO.

A refractive index variation based on the interference pattern of the information beam IL1 and the reference beam RL1a is recorded as the page data in the information recording medium HO. This recording can multiply record the multiple page data in the same location of the information recording medium HO by recording while changing the irradiation angle θy. The refractive index variation based on the interference pattern of the information beam IL1 and the reference beam RL1b is recorded as other page data at a different irradiation angle θz. Similarly, this recording also can multiply record the multiple page data in the same location of the information recording medium HO by recording while changing the irradiation angle θy. As illustrated in FIG. 5A, the irradiation angle θz is the angle around the z axis.

After the page data is recorded, the shutter S2 is closed.

Thus, one page of page data is recorded in the information recording medium HO. Similarly, other page data is recorded by changing the irradiation positions x and y or the irradiation angles θx1 and θy1 of the reference beams RL1a and RL1b.

The reference beams RL1a and RL1b pass through two optical paths and are irradiated onto the information recording medium HO at two different angles to perform multiplex recording of the page data in the same location of the information recording medium HO, which is a holographic storage medium.

Although FIG. 21 illustrates a configuration in which angular multiplex recording is performed using the two reference beams RL1a and RL1b, multiplex recording of an arbitrary number is possible.

The irradiation angles of the reference beams RL1a and RL1b may be changed; or the information recording medium HO may be rotated around the y axis as illustrated in FIG. 4 (θy1 rotation).

The information recording medium HO in which the interference pattern of the reference beam RL1 and the information beam IL1 is recorded can be made, for example, as recited above.

What is claimed is:

1. An information reproduction apparatus, comprising:
an information acquisition unit configured to irradiate a reference beam, convert the reference beam into a luminance signal using a first light detector, and output the luminance signal when reproducing an information recording medium, an interference pattern of the reference beam and an information beam being formed in the information recording medium;
an error detection unit configured to detect at least one selected from a first error and a second error by extracting a feature extraction quantity from the luminance signal, the first error being of an irradiation angle of the reference beam, the second error being of at least one selected from a temperature when reproducing the information recording medium and a wavelength of the reference beam; and
a control unit configured to control at least one selected from the irradiation angle of the reference beam relative to the information recording medium using the first error and the at least one selected from the reproduction temperature and the wavelength of the reference beam using the second error.

2. The apparatus according to claim 1, wherein
the information acquisition unit further includes a second light detector having a resolution lower than a resolution of the first light detector, and
the error detection unit is configured to extract the feature extraction quantity from an output of the second light detector.

3. The apparatus according to claim 1, wherein
the feature extraction quantity includes a tilt of a straight line when the luminance signal is approximated by the straight line, and
the error detection unit is configured to detect the first error from the feature extraction quantity.

4. The apparatus according to claim 1, wherein:
the feature extraction quantity includes a change of a tilt of a straight line, the luminance signal being approximated by the straight line when the relative irradiation angle between the reference beam and the information recording medium is changed around a first axis; and
the error detection unit is configured to detect a polarity of the first error from the feature extraction quantity, the first error being an angle around a second axis,
the first and second axes being mutually orthogonal in a plane of the information recording medium.

5. The apparatus according to claim 4, wherein the first axis is an axis of a direction having an angular selectivity higher than an angular selectivity of the second axis.

6. The apparatus according to claim 4, wherein the first axis is an axis having angular multiplex recording performed for different irradiation angles of the reference beam.

7. The apparatus according to claim 1, wherein
the feature extraction quantity includes a center position of a circular ring when the luminance signal is approximated by the circular ring, and
the error detection unit is configured to detect the second error from the feature extraction quantity.

8. The apparatus according to claim 1, wherein
the feature extraction quantity includes a reciprocal of a radius (a curvature) of a circular ring when the luminance signal is approximated by the circular ring, and
the error detection unit is configured to detect the second error from the feature extraction quantity.

9. The apparatus according to claim 1, wherein a servo gain of the first error is set to be larger than a servo gain of he second error in the control unit.

10. The apparatus according to claim 1, wherein the error detection unit causes the irradiation angle of the reference beam to be offset around one axis selected from a first axis and a second axis,
the first and second axes being mutually orthogonal in a plane of the information recording medium.

11. A method for controlling an information reproduction apparatus configured to reproduce recorded information from an information recording medium, an interference pattern of a reference beam and an information beam being formed in the information recording medium, the method comprising:
irradiating the reference beam onto the information recording medium;
acquiring a luminance signal of the information beam including the recorded information by the reference beam being diffracted by the information recording medium;
detecting at least one selected from a first error and a second error by extracting a feature extraction quantity from the luminance signal, the first error being of an irradiation angle of the reference beam, the second error being of at least one selected from a temperature when reproducing the information recording medium and a wavelength of the reference beam; and
controlling at least one selected from the irradiation angle of the reference beam relative to the information recording medium using the first error and the at least one selected from the reproduction temperature and the wavelength using the second error.

12. The method according to claim 11, wherein
the feature extraction quantity includes a tilt of a straight line when the luminance signal is approximated by the straight line, and
the first error from the feature extraction quantity is detected.

13. The method according to claim 11, wherein:
the feature extraction quantity includes a change of a tilt of a straight line, the luminance signal being approximated by the straight line when the relative irradiation angle between the reference beam and the information recording medium is changed around a first axis; and
a polarity of the first error from the feature extraction quantity is detected, the first error being an angle around a second axis,
the first and second axes being mutually orthogonal in a plane of the information recording medium.

14. The method according to claim 13, wherein the first axis is an axis of a direction having an angular selectivity higher than an angular selectivity of the second axis.

15. The method according to claim 13, wherein the first axis is an axis having angular multiplex recording performed for different irradiation angles of the reference beam.

16. The method according to claim 11, wherein
the feature extraction quantity includes a center position of a circular ring when the luminance signal is approximated by the circular ring, and
the second error from the feature extraction quantity is detected.

17. The method according to claim 11, wherein
the feature extraction quantity includes a reciprocal of a radius (a curvature) of a circular ring when the luminance signal is approximated by the circular ring, and
the second error from the feature extraction quantity is detected.

18. The method according to claim 11, wherein a servo gain of the first error is set to be larger than a servo gain of the second error.

19. The method according to claim 11, wherein detecting is performed causing the irradiation angle of the reference beam to be offset around one axis selected from a first axis and a second axis,
the first and second axes being mutually orthogonal in a plane of the information recording medium.

20. The method according to claim 11, wherein the feature extraction quantity is acquired from a signal having a resolution lower than a resolution of the luminance signal of the information beam.
